(19) United States
(12) Patent Application Publication
(10) Pub. No.: US 2012/0194394 A1
(43) Pub. Date: Aug. 2, 2012

(54) PORTABLE ELECTRONIC DEVICE

(75) Inventors: Daisuke TOGASHI, Kanagawa (JP); Akiyoshi NODA, Kanagawa (JP); Yoshiaki HIRAOKA, Kanagawa (JP); Ting LU, Kanagawa (JP)

(73) Assignee: KYOCERA CORPORATION, Kyoto (JP)

(21) Appl. No.: 13/360,361

(22) Filed: Jan. 27, 2012

(30) Foreign Application Priority Data
Jan. 27, 2011 (JP) 2011-015008
Jan. 27, 2011 (JP) 2011-015270
Jan. 27, 2011 (JP) 2011-015271
Jan. 27, 2011 (JP) 2011-015311
Jun. 27, 2011 (JP) 2011-141397

(51) Int. Cl. H01Q 1/24

(52) U.S. Cl. 343/702

(57) ABSTRACT

To provide a portable electronic device that includes an antenna that has a novel configuration that uses a conductive portion. The portable electronic device includes an operation unit side body that has a first conductive portion; a display unit side body that has a second conductive portion; a connecting portion that has a third conductive portion, and connects the operation unit side body and the display unit side body to enable transition between a closed state and an opened state; and a power feed unit. The cellular telephone device enables operation as a magnetic current antenna by power supply from a power feed unit to an opposed region that is formed by enclosure of at least three sides by the first conductive portion, the second conductive portion, and the third conductive portion.

This application is based on and claims the benefit of priority from Japanese Patent Application Nos. 2011-015311, 2011-015008, 2011-015270, 2011-015271 and 2011-141397, respectively filed on 27 Jan. 2011, filed on 27 Jan. 2011, filed on 27 Jan. 2011, filed on 27 Jan. 2011 and filed on 27 Jun. 2011, the content of which is incorporated herein by reference.

### BACKGROUND OF THE INVENTION

1. Field of the Invention

The present invention relates to a portable electronic device that includes an antenna and that executes communication with an external device.

2. Related Art

Progress is continuing in the downsizing and width reduction of portable electronic devices, and such devices store antennas in a variety of configurations. For example, Japanese Unexamined Patent Application, Publication No. 2008-167420 discloses a technique of forming a notched portion in a first conductive portion disposed in a first body and supplying power to the notched portion to thereby operate the notched portion as a slot antenna.

### SUMMARY OF THE INVENTION

However, there is a need for an antenna technique in relation to this type of portable electronic device that makes further use of a conductive portion.

The present invention has a first object of providing a portable electronic device that includes an antenna having a novel configuration that uses a conductive portion.

In order to solve the above problems, the portable electronic device according to the present invention includes a first body that has a first conductive portion, a second body that has a second conductive portion, a connecting portion that has a third conductive portion and is configured to connect to enable transition between a closed state and an opened state, and a power feed unit. In the opened state, the first conductive portion and the second conductive portion are electrically connected through the third conductive portion. In the opened state, an opposed region that is formed by enclosure of at least three sides by the first conductive portion, the second conductive portion, and the third conductive portion is supplied with power from the power feed unit to operate as a magnetic current antenna.

The connecting portion may be configured to rotatably connect the first body and the second body about a predetermined rotation axis to enable transition between a closed state in which the first body and the second body are disposed in a stacked configuration, and an opened state in which a mutually opposed surface of the first body and the second body in the closed state is exposed.

The first conductive portion and the second conductive portion may be mutually opposed in the closed state, and the power feed unit may be connected to either one of the first conductive portion and the second conductive portion in the closed state.

The second conductive portion may be not electrically conductive in relation to the first conductive portion and the third conductive portion in the closed state, and is also not electrically conductive in relation to a reference potential unit. The power feed unit may be connected to the second conductive portion in the closed state.

The connecting portion may be configured to connect the first body and the second body to enable transition between the closed state in which the first body and the second body are disposed in a stacked configuration, and an opened state in which an upper surface of the first body and an upper surface of the second body are disposed to be visible from the same direction.

The first opening may be formed in the second conductive portion to operate as a second magnetic current antenna by supply of power from the power feed unit in a closed state to the end on the opposite side to the end on the side forming the opposed region in the opened state. The first notched portion may be formed in the first conductive portion in a region opposed to the first opening in the closed state, the region forming the opposed region in the opened state.

The first opening and the first notched portion may be configured in an elongated configuration, and the longitudinal length of the first notched portion may be greater than or equal to the longitudinal length of the first opening.

The first magnetic current antenna and the second magnetic current antenna may operate in the same resonance frequency band.

The second opening may be formed in the first conductive portion to operate as a third magnetic current antenna by supply of power from the power feed unit in the closed state to the end on the opposite side to the end on the side forming the opposed region in the opened state. The second notched portion may be formed in the second conductive portion in a region opposed to the second opening in the closed state, the region forming the opposed region in the opened state.

The second opening and the second notched portion may be formed in an elongated configuration, and the longitudinal length of the second notched portion may be greater than or equal to the longitudinal length of the second opening.

The power feed unit may further include a first power feed unit. The connecting portion may be configured to connect the first body and the second body to enable transition between a closed state in which the principal surface of the first body and the principal surface of the second body are opposed and disposed with respect to a direction of stacking, and an opened state in which the second body slides in a horizontal direction with respect to the first body from the closed state, a portion of the principal surface of the first body is exposed, and another portion is covered by the principal surface of the second body. In either or both of the opened state and the closed state, the first conductive portion and the second conductive portion may be electrically connected through the third conductive portion. In either or both of the opened state and the closed state, the opposed region that is formed by enclosure of at least three sides by the first conductive portion, the second conductive portion, and the third conductive portion may be supplied with power from the first power feed unit to operate as a magnetic current antenna.

The power feed unit may further include a second power feed unit. The second conductive portion may include a first portion and a second portion, and the third conductive portion may include a first portion and a second portion. The first conductive portion and the first portion of the second conductive portion may be electrically connected through the first portion of the third conductive portion. An opposed region that is enclosed by the first conductive portion, the first portion of the second conductive portion and the first portion of the third conductive portion may be supplied with power from the first power feed unit to operate as a magnetic current antenna. The first conductive portion and the second portion of the second conductive portion may be electrically connected through the second portion of the third conductive portion, and the second portion of the second conductive portion may be supplied with power from the second power feed unit to operate as an inverted F antenna.

The portable electronic device may further include a control unit that operates one of the first power feed unit and the third power feed unit. The power feed unit may include a third power feed unit. The first conductive portion and the second conductive portion may include opposed surfaces that are mutually opposed in the opened state and the closed state. The end on one side in the planar direction of the opposed surface may be supplied with power from the first power feed unit to operate as a first magnetic current antenna. The end on the other side in the planar direction of the opposed region may be supplied with power from the third power feed unit to operate as a second magnetic current antenna. The control unit may compare a communication quality of the first magnetic current antenna and a communication quality of the second magnetic current antenna, and execute control to perform communication using the magnetic current antenna that has the higher communication quality.

The connecting portion may be configured to connect the first body and the second body to enable transition between a closed state in which the principal surface of the first body and the principal surface of the second body are opposed by disposing in a stacked configuration, a first opened state in which the first body is rotated through a predetermined angle in relation to the second body about a first rotation axis enabling rotation from the closed state to a first direction, and in which the principal surface of the first body and the principal surface of the second body are exposed to be visible from the same direction, and a second opened state in which the second body is rotated through a predetermined angle in a planar direction about a second rotation axis enabling rotation from the first opened state in a second direction that is orthogonal to the first direction and with the principal surface of the first body and the principal surface of the second body remaining visible from the same direction. The first conductive portion and the second conductive portion may be electrically connected through the third conductive portion. In the first opened state, the opposed region that is formed by enclosure of at least three sides by the first conductive portion, the second conductive portion, and the third conductive portion may be supplied with power from the power feed unit to operate as a magnetic current antenna.

In the second opened state, the first conductive portion and the second conductive portion may be electrically connected through the third conductive portion. In the second opened state, the opposed region that is formed by enclosure of at least three sides by the first conductive portion, the second conductive portion, and the third conductive portion may be supplied with power from the power feed unit to operate as a magnetic current antenna.

The second conductive portion may form a first slit having a predetermined shape on the end facing the connecting portion in the first opened state, and a second slit having a predetermined shape on the end facing the connecting portion in the second opened state. The third conductive portion may form a third slit having a predetermined shape in a longitudinal direction and a fourth slit having a predetermined shape in a transverse direction. One end of the third slit and one end of the fourth slit may be joined and integrally formed. The second slit, the third slit and the fourth slit may form an integrated slit by joining of an end of the second slit and the other end of the fourth slit in the first opened state, and be supplied with power from the power feed unit to operate as a magnetic current antenna. The first slit, the third slit and the fourth slit may form an integrated slit by joining of an end of the first slit and the other end of the third slit in the second opened state, and be supplied with power from the power feed unit to operate as a magnetic current antenna.

The first conductive portion may form a fifth slit having a predetermined shape on the end facing the connecting portion. The first slit and the fifth slit may form an integrated slit by joining the ends in the first opened state, and be supplied with power from the power feed unit to operate as a magnetic current antenna. The second slit and the fifth slit may form an integrated slit by joining the ends in the second opened state, and be supplied with power from the power feed unit to operate as a magnetic current antenna. The first slit and the second slit may be configured with an equivalent size.

The first conductive portion may form a sixth slit having a predetermined shape on the end facing the connecting portion. The second conductive portion may form a seventh slit having a predetermined shape on the end facing the connecting portion in the first opened state, an eighth slit having a predetermined shape on the end facing the connecting portion in the second opened state, and a ninth slit having a predetermined shape on the extension line of the eighth slit. The third conductive portion may form a tenth slit having a predetermined shape in a longitudinal direction. The sixth slit, the seventh slit, and the tenth slit may form an integrated slit by joining the ends in the first opened state, and be supplied with power from the power feed unit to operate as a magnetic current antenna. The sixth slit, the eighth slit, the ninth slit and the tenth slit may form an integrated slit by joining the ends in the second opened state, and be supplied with power from the power feed unit to operate as a magnetic current antenna.

In order to solve the above problems, the portable electronic device according to the present invention includes a first body that has a first conductive portion, a second body that has a second conductive portion, a connecting portion that has a third conductive portion, and is configured to connect the first body and the second body to enable adoption of a closed state in which the principal surface of the first body and the principal surface of the second body are opposed by disposing in a stacked configuration, a first opened state in which the first body is rotated through a predetermined angle in relation to the second body about a first rotation axis enabling rotation from the closed state to the first direction, and in which the principal surface of the first body and the principal surface of the second body are exposed to be visible from the same direction, and a second opened state in which the second body is rotated through a predetermined angle in a planar direction about a second rotation axis enabling rotation from the first opened state in a second direction that is orthogonal to the first direction, and with the principal surface of the first body and the principal surface of the second body remaining visible from the same direction, and a power feed unit. The first conductive portion may form a sixth slit having a predetermined shape on the end facing the connecting portion. The second conductive portion may form a seventh slit having a predetermined shape on the end facing the connecting portion in the first opened state, an eighth slit having a predetermined shape on the end facing the connecting portion in the second opened state, and a ninth slit having a predetermined shape on the extension line of the eighth slit. The third conductive portion may form a tenth slit having a predetermined shape in a longitudinal direction. The sixth slit, the seventh slit, and the tenth slit may form an integrated slit by joining the ends in the first opened state, and be supplied with power from the power feed unit to operate as a magnetic current antenna. The sixth slit, the eighth slit, the ninth slit and the tenth slit may form an integrated slit by joining the ends in the second opened state, and be supplied with power from the power feed unit to operate as a magnetic current antenna.

The connecting portion may be configured to connect the first body and the second body to enable transition between a closed state stacking and disposing the second body on the first body, and an opened state in which the second body is rotated from the closed state through a predetermined angle in relation to the second body about an axis along the direction of stacking. In the opened state, the first conductive portion and the second conductive portion may be electrically connected through the third conductive portion.

The third conductive portion may be configured from a metal plate member for fixing the first body and the second body. In the opened state, the first conductive portion and the second conductive portion may be electrically connected through the metal plate member, and in the opened state, the opposed region may be a region that is formed by enclosure of three sides by the first conductive portion, the second conductive portion, and the metal plate member.

One end of the first conductive portion and one end of the metal plate member facing the one end of the first conductive portion may be electrically connected by a first connection member having conductive properties. One end of the second conductive portion and another end of the metal plate member facing the one end of the second conductive portion may be electrically connected by a second connection member having conductive properties. In the opened state, a first opposed region and a second opposed region formed by enclosure of three sides by the one end of the first conductive portion, the one end of the metal plate member, and the first connection member may be respectively supplied with power from the power feed unit to operate as a magnetic current antenna. In the opened state, a third opposed region and a fourth opposed region formed by enclosure of three sides by one end of the second conductive portion, another end of the metal plate member, and the second connection member may be respectively supplied with power from the power feed unit to operate as a magnetic current antenna. In the closed state, the first opposed region and the fourth opposed region face the direction of stacking, and in the closed state, either one of the first opposed region and the fourth opposed region may be supplied with power from the power feed unit to operate as a magnetic current antenna. In the closed state, the second opposed region and the third opposed region face the direction of stacking, and either one of the second opposed region and the third opposed region may be supplied with power from the power feed unit to operate as a magnetic current antenna.

In a rotating state between the opened state and the closed state, the first opposed region and the third opposed region, or the second opposed region and the fourth opposed region in which the opposed region is not covered in the direction of stacking may be supplied with power from the power feed unit and operate as a slit-shaped magnetic current antenna. Since a portion of the opposed region is covered in the direction of stacking, the region formed by the first opposed region and the third opposed region, or the second opposed region and the fourth opposed region may be supplied with power from the power feed unit and operate as a slot-shaped magnetic current antenna.

The second conductive portion may form a first notched portion and a second notched portion having a predetermined shape and exhibiting bilateral symmetry in the longitudinal direction. The metal plate member is disposed to divide the first notched portion and the second notched portion. A first slit, a second slit, a third slit and a fourth slit are formed, and in a process of transition from the opened state to an intermediate state between the opened state and the closed state, the third slit or the fourth slit which are not covered in the direction of stacking may be supplied with power from the power feed unit and operate as a magnetic current antenna. In the process of transition from the intermediate state to the closed state, the first slit or the second slit which are not covered in the direction of stacking may be supplied with power from the power feed unit and operate as a magnetic current antenna.

The first conductive portion or the second conductive portion may be connected to a reference potential, and the first conductive portion and the second conductive portion may be configured with a high frequency connection through the connecting portion to operate as an inverted F antenna.

A plurality of opposed regions formed by enclosure of three sides by the first conductive portion, the second conductive portion and the third conductive portion may be formed with the same length on each side, and supplied with power from the power feed unit to operate as a magnetic current antenna that executes sending and receiving operations in the same resonance frequency band.

The present invention provides a portable electronic device that has an antenna having a novel configuration that uses a conductive portion.

### BRIEF DESCRIPTION OF THE DRAWINGS

FIG. 1 illustrates the external appearance when a cellular telephone device according to a first embodiment is in an opened state;

FIG. 2 illustrates the external appearance when the cellular telephone device according to the first embodiment is in a closed state;

FIG. 3A and FIG. 3B are schematic figures illustrating the internal structure of the cellular telephone device according to the first embodiment;

FIG. 4 is a schematic figure illustrating the internal structure of the cellular telephone device according to a third embodiment;

FIG. 5 is a schematic figure illustrating the internal structure of the cellular telephone device according to a fourth embodiment;

FIG. 6 is an external perspective view when the cellular telephone device according to a fifth embodiment is in a closed state;

FIG. 7 is an external perspective view of the cellular telephone device in an opened state;

FIG. 8 describes a transition of the cellular telephone device between a closed state and an opened state;

FIG. 9A and FIG. 9B are schematic figures illustrating the internal structure of the cellular telephone device;

FIG. 10 is an external perspective view when the cellular telephone device according to a sixth embodiment is in a slide-down state (closed state);

FIG. 11 is an external perspective view when the cellular telephone device is in a slide-up state (opened state);

FIG. 12 describes the operation of a magnetic current antenna;

FIG. 13A and FIG. 13B describe the operation of a magnetic current antenna;

FIG. 14A and FIG. 14B describe the operation of a magnetic current antenna;

FIG. 15A and FIG. 15B describe the operation of a magnetic current antenna;

FIG. 16A and FIG. 16B describe the operation of a magnetic current antenna in an opened state and a closed state;

FIG. 17A and FIG. 17B describe the operation of a magnetic current antenna;

FIG. 18 describes the operation of a magnetic current antenna;

FIG. 19 describes the operation of a magnetic current antenna;

FIG. 20 illustrates the external appearance when the cellular telephone device according to a seventh embodiment is in a first opened state;

FIG. 21 is a sectional view when the cellular telephone device is seen from the side when in the first opened state;

FIG. 22 is an external view when the cellular telephone device is in a closed state;

FIG. 23 is an external view when the cellular telephone device is in a second opened state (intersecting state);

FIG. 24A and FIG. 24B describe a magnetic current antenna that operates when the cellular telephone device has executed a transition to a first opened state and a second opened state;

FIG. 25 describes the method of connecting the conductive portions disposed on different base plates;

FIG. 26A and FIG. 26B describe a magnetic current antenna that operates when the cellular telephone device has executed a transition to a first opened state and a second opened state;

FIG. 27 is an external view when a cellular telephone device according to an eighth embodiment is in an opened state;

FIG. 28 is an external view of the cellular telephone device after rotation through 90 degrees in a clockwise direction;

FIG. 29 is an external view of the cellular telephone device in a closed state;

FIG. 30 is a schematic diagram of the configuration of the cellular telephone device (first configuration example);

FIG. 31A and FIG. 31B are schematic diagrams of the configuration of the cellular telephone device (second configuration example);

FIG. 32 describes an example of a slot antenna configured as a region having a quadrilateral shape formed after rotation through 90 degrees in a clockwise direction;

FIG. 33 describes an example of a slot antenna configured as a region having a quadrilateral shape formed after rotation through 90 degrees in a clockwise direction;

FIG. 34 is a schematic diagram of the configuration of the cellular telephone device (third configuration example);

FIG. 35A and FIG. 35B are schematic diagrams of the configuration of the cellular telephone device in the intermediate state and closed state;

FIG. 36 is a schematic diagram of the configuration of the cellular telephone device (fourth configuration example); and

FIG. 37A and FIG. 37B are schematic diagrams of the configuration of the cellular telephone device (fifth configuration example).

### DETAILED DESCRIPTION OF THE INVENTION

### First Embodiment

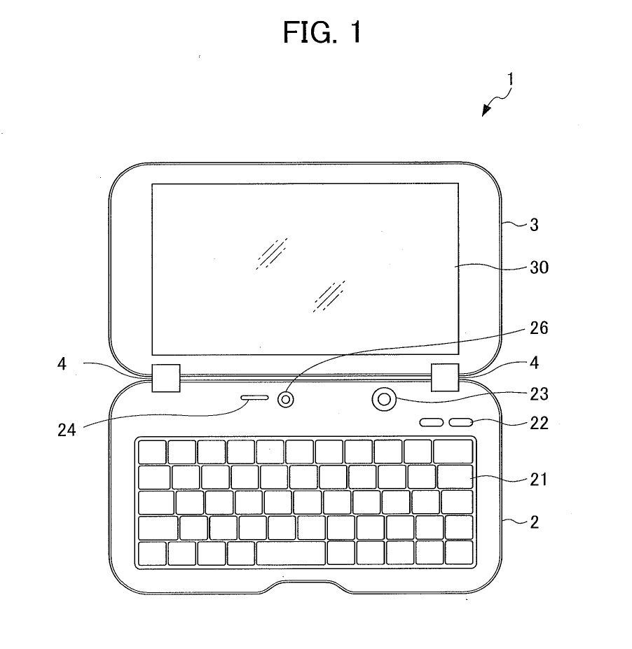

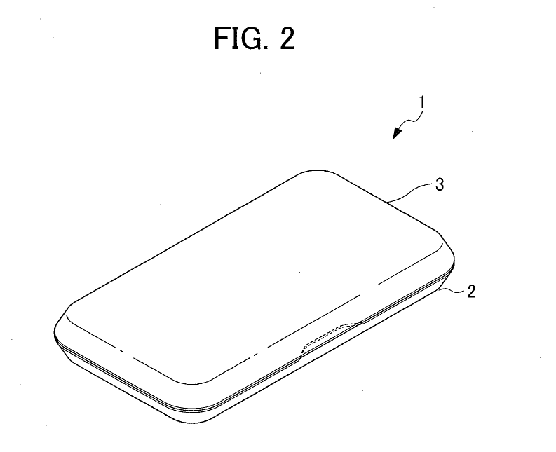

The embodiments of the present invention will be described below. FIG. 1 and FIG. 2 illustrate the external appearance of a cellular telephone device 1 as an example of a portable electronic device according to the first embodiment of the present invention. Although the following embodiments describe a cellular telephone device 1, the present invention is not limited to a cellular telephone device, and for example, application is possible in relation to personal handy phone system (PHS), personal digital assistants (PDA), portable navigation apparatuses, notebook personal computers, and the like.

The cellular telephone device 1 includes an operation unit side body 2 (first body), a display unit side body 3 (second body), and a connecting portion 4 that connects the operation unit side body 2 and the display unit side body 3.

A planar surface (surface) of the operation unit side body 2 includes an operation key set 21, a function button set 22 that receives the start-up or stopping of a conversation or the ON/OFF operation of the power source, a trackball 23 used to displace a cursor displayed on a display unit 30 described below, a speaker 24 that outputs audio of conversation partner, and a moveable pin 26. A planar surface (surface) of the display unit side body 3 includes a display unit 30 that executes various types of display in accordance with a function provided to the cellular telephone device 1.

The cellular telephone device 1 can freely use the connecting portion 4 described below to execute a transition to an opened state that is the state illustrated in FIG. 1 and a closed state that is the state illustrated in FIG. 2. The closed state is the state in which the planar surface of the operation unit side body 2 and the planar surface of the display unit side body 3 are disposed in a stacked configuration in an opposed configuration. The opened state is a state in which the opposed surfaces of the operation unit side body 2 and the display unit side body 3 in the closed state are exposed, that is to say, the state in which the planar surface of the operation unit side body 2 and the planar surface of the display unit side body 3 are aligned.

The connecting portion 4 rotatably connects the operation unit side body 2 and the display unit side body 3 about a predetermined rotation axis.

The cellular telephone device 1 is configured from other constituent elements in addition to those described above. For example, although the cellular telephone device 1 is omitted from the figures, it includes an imaging unit configured from a charge coupled device (CCD) camera, a complementary metal oxide semiconductor (CMOS) camera, or the like, a microphone for input of audio produced by a user during conversations, and the like.

The cellular telephone device 1 having the above configuration is configured to enable a configuration of a plurality of antennas by use of a conductive portion. The specific configuration will be described below.

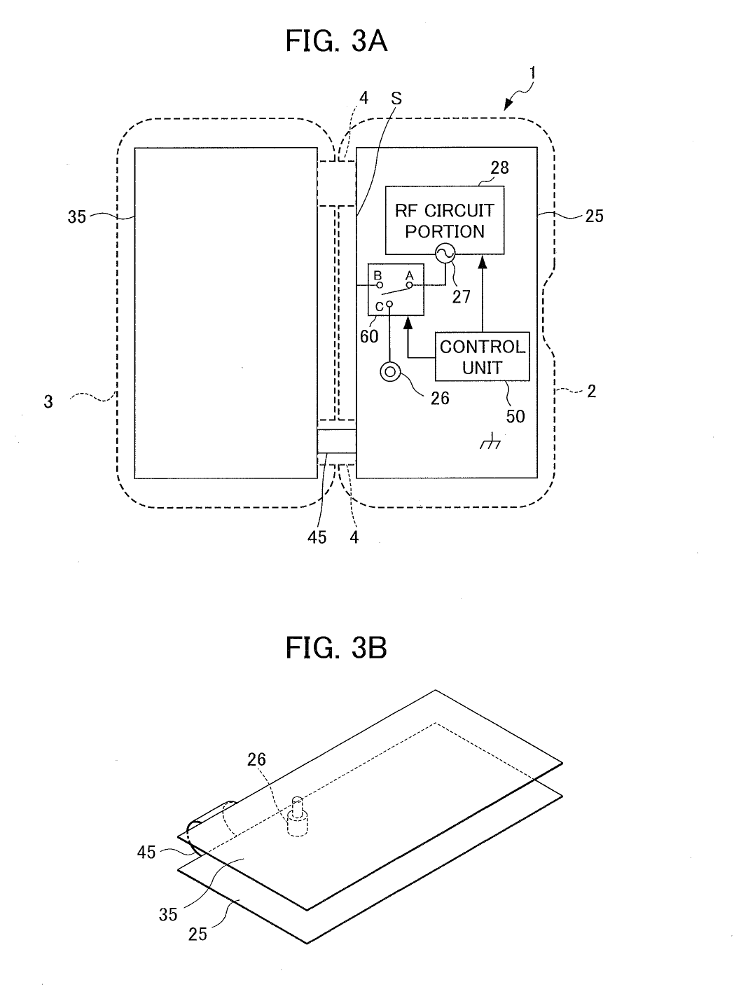

FIG. 3 is a schematic figure illustrating the internal structure of the cellular telephone device 1 according to the first embodiment of the present invention.

FIG. 3A is a schematic figure illustrating the internal structure of the cellular telephone device 1 in an opened state, and FIG. 3B is a schematic figure illustrating the internal structure of the cellular telephone device 1 in a closed state. As illustrated in FIG. 3A, the operation unit side body 2 of the cellular telephone device 1 includes a first conductive portion 25, a moveable pin 26, a power feed unit 27, an RF circuit portion 28, a control unit 50, and a switch unit 60. The display unit side body 3 of the cellular telephone device 1 includes a second conductive portion 35. The connecting portion 4 of the cellular telephone device 1 includes a third conductive portion 45.

In the cellular telephone device 1, an opposed region S having a predetermined spatial dimension is formed by enclosure of three sides by the first conductive portion 25, the second conductive portion 35, and the third conductive portion 45 in the opened state. In a first embodiment, although the opposed region S enclosed on three sides is formed, two third conductive portions 45 may be provided, and an opposed region S may be formed to have a predetermined spatial dimension by enclosure of four sides by the first conductive portion 25, the second conductive portion 35, and the two third conductive portions 45.

The first conductive portion 25 is disposed on an inner portion of the operation unit side body 2, and is configured by a plate-shaped metal plate having a substantially rectangular parallelepiped shape and that conducts electricity. A reference potential unit is provided in the first conductive portion 25 to maintain a predetermined potential.

The second conductive portion 35 is disposed on an inner portion of the display unit side body 3, and is configured by a tabular metal plate that has a substantially rectangular parallelepiped shape and that conducts electricity. The second conductive portion 35 executes supply of power from the power feed unit 27 through the moveable pin 26 in a closed state.

The third conductive portion 45 is disposed on an inner portion of the connecting portion 4, and is configured from a conductive body such as a metal, or the like. The third conductive portion 45 is disposed in contact with the first conductive portion 25 and the second conductive portion 35 in the opened state and the closed state. When disposed in this manner, the third conductive portion 45 configures an electrical connection between the first conductive portion 25 and the second conductive portion 35 in the opened state and the closed state.

The moveable pin 26 is configured from a conductive body such as a metal, or the like. As illustrated in FIG. 3B, the moveable pin 26 is connected to the second conductive portion 35 in the closed state.

The power feed unit 27 enables electrical connection through a switch unit 60 with the moveable pin 26 and a power feed point on a peripheral edge portion of the surface that forms the opposed region S of the first conductive portion 25, in addition to being connected with the RF circuit unit 28. The power feed unit 27 enables power supply to the opposed region S or the second conductive portion 35 through the switch portion 60 in response to the control of the control unit 50. The control unit 50 connects the moveable connection point A of the switch unit 60 to the fixed connection point B when the opened state is detected, and connects the moveable point A of the switch unit 60 to the fixed connection point C when the closed state is detected. The detection of the opened state or the closed state is executed by use of a conventional technology such as a magnetic switch, or the like, and a signal indicating the opened state or the closed state is supplied to the control unit 50.

In other words, the power feed unit 27 executes power supply to the opposed region S when in the opened state, and the opposed region S is operated as an antenna element. In this manner, an electrical field is generated in the opposed region S and thereby operates as a magnetic current antenna (in other words, a slot antenna or slit antenna). The longitudinal length of the opposed region S is preferably nλ/2 (n=1, 2, 3, . . . ) in relation to a wave length λ corresponding to a desired resonance frequency f.

The power feed unit 27 executes power supply to the second conductive portion 35 through the moveable pin 26 when in the closed state, and thereby operates the second conductive portion 35 as an antenna element. In other words, when power supply is executed in relation to the second conductive portion 35 by the power feed unit 27 when in the closed state, the first conductive portion 25 and the second conductive portion 35 are electrically connected through the third conductive portion 45. The first conductive portion 25, the second conductive portion 35, and the third conductive portion 45 operate as an inverted F antenna as a result of power supply to the second conductive portion 35 when in the closed state.

The RF circuit unit 28 is connected to the control unit 50 that controls the whole of the cellular telephone device 1, and executes supply of power to the opposed region S or the second conductive portion 35 through the power feed unit 27 in response to supply of a signal from the control unit. In FIG. 3A, although the power feed unit 27 and the RF circuit unit 28 are displayed as a separate configuration, the power feed unit 27 may be included in the RF circuit portion 28.

According to the first embodiment, the first conductive portion 25 and the second conductive portion 35 of the cellular telephone device 1 are electrically connected through the third conductive portion 45, and the opposed region S formed by enclosure of at least three sides formed by the first conductive portion 25, the second conductive portion 35 and the third conductive portion 45 is supplied with power by the power feed unit 27 and operates as a magnetic current antenna.

In this configuration, since the cellular telephone device 1 operates the opposed region S formed in an opened state as a magnetic current antenna, a configuration for a novel antenna using a conductive portion can be realized.

The power feed unit 27 of the cellular telephone device 1 is connected to the second conductive portion 35 through the moveable pin 26 in the closed state, and executes power supply to the second conductive portion 35.

In this configuration, power supply to the second conductive portion 35 is executed in the cellular telephone device 1 when in the closed state. When in the closed state, the first conductive portion 25 and the second conductive portion 35 are short circuited by the third conductive portion 45, and a predetermined potential is maintained by the reference potential unit. Therefore, the cellular telephone device 1 enables operation of the first conductive portion 25, the second conductive portion 35, and the third conductive portion 45 in the closed state as an inverted F antenna. When an antenna is not configured in the closed state in the first embodiment, it is clear that there is no requirement to provide the moveable pin 26 and the switch unit 60.

### Second Embodiment

Herein, the third conductive portion 45 may be disposed to not make contact with the first conductive portion 25 and the second conductive portion 35 when in the closed state.

In this configuration, the second conductive portion 35 is electrically connected to the first conductive portion 25 through the third conductive portion 45 in the opened state. Furthermore, the second conductive portion 35 is not electrically conductive in relation to the first conductive portion 25 and the third conductive portion 45 in the closed state.

According to the second embodiment, the second conductive portion 35 is not electrically conductive in relation to the first conductive portion 25 and the third conductive portion 45 in the closed state, nor is electrically conductive in relation to the reference potential unit. The power feed unit 27 is connected to the second conductive portion 35 in the closed state, and executes power supply to the second conductive portion 35.

In this configuration, the first conductive portion 25 and the second conductive portion 35 of the cellular telephone device 1 are electrically connected through the third conductive portion 45, and an opposed region S that is formed by enclosure of at least three sides by the first conductive portion 25, the second conductive portion 35, and the third conductive portion 45 is supplied with power from the power feed unit 27 to thereby operate as a magnetic current antenna.

The first conductive portion 25 and the second conductive portion 35 of the cellular telephone device 1 are not electrically conductive in the closed state, and the second conductive portion 35 for example operates as a monopole antenna due to supply of power to the second conductive portion 35 from the power feed unit 27.

### Third Embodiment

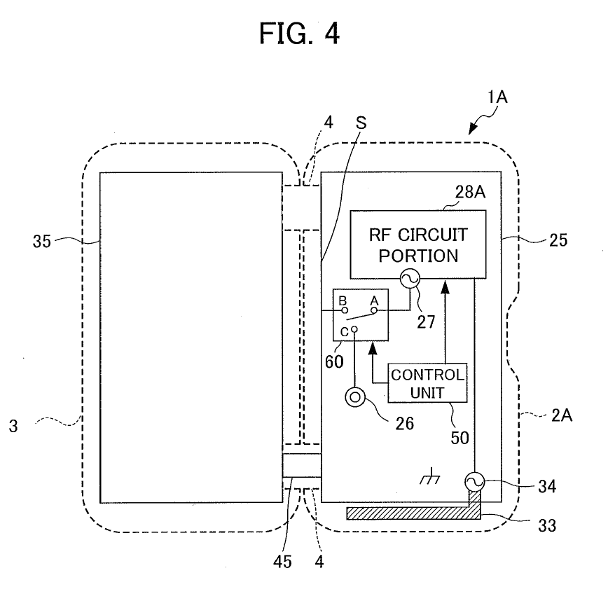

FIG. 4 is a schematic figure illustrating the internal structure of a cellular telephone device 1A according to the third embodiment of the present invention. The third embodiment differs from the first embodiment in relation to the point that an L-shaped antenna formed from a metal plate or the like and a power feed unit corresponding to the antenna is provided. Description of those aspects of configuration that are the same as the first embodiment will not be repeated.

An L-shaped antenna 33 formed from metal plate or the like and a power feed unit 34 that is connected to the end on the transverse side of the antenna are provided on the operating unit side body 2A. The power feed unit 34 is connected to the RF circuit unit 28A.

The RF circuit unit 28A is connected to the control unit 50 that controls the overall operation of the cellular telephone device 1A, and executes power supply to the opposed region S, the second conductive portion 35 and the antenna 33 through the power feed units 27, 34 in response to a signal supplied from the control unit 50. In this configuration, in the opened state, the opposed region S operates as a magnetic current antenna in addition to operation of the antenna 33. Furthermore, in the closed state, the first conductive portion 25, the second conductive portion 35, and the third conductive portion 45 operate as an inverted F antenna in addition to operation of the antenna 33.

As described above, the cellular telephone device 1A in the third embodiment operates the opposed region S in the opened state as a magnetic current antenna and enables operation of the antenna 33. When the cellular telephone device 1A is in the closed state, the first conductive portion 25, the second conductive portion 35, and the third conductive portion 45 operate as an inverted F antenna, and in addition enables operation of the antenna 33.

Since a low correlation can be expected between the magnetic current antenna due to the opposed region S and the antenna 33, the cellular telephone device 1A enables application of a plurality of low-correlation antennas for diversity when in the opened state. Since a low correlation can be expected between the inverted F antenna configured by the first conductive portion 25, the second conductive portion 35, and the third conductive portion 45, and the antenna 33, the cellular telephone device 1A enables application of a plurality of low-correlation antennas for diversity when in the closed state.

### Fourth Embodiment

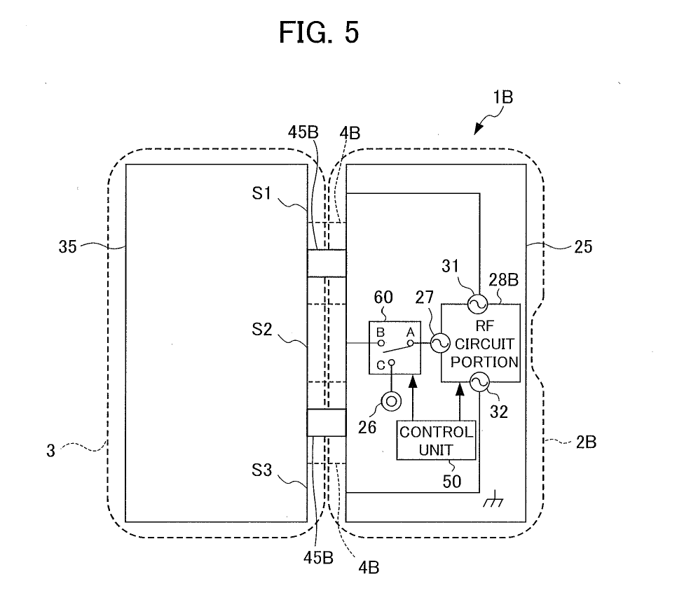

FIG. 5 is a schematic figure illustrating the internal structure of a cellular telephone device 1B according to the fourth embodiment of the present invention. In the fourth embodiment, the position of the connecting portion, the position and number of the third conductive portions, the number of the power feed units, and the configuration of the switch differ from the first embodiment. Description of those aspects of configuration that are the same as the first embodiment will not be repeated.

The distance between the two connecting portions 4B is shorter when compared with the distance between the two connecting portions 4 in the first embodiments, and the connecting portion 4B connects the operation unit side body 2B and the display unit side body 3. The third conductive unit 45B is provided respectively in relation to the two connecting units 4B, and is disposed to make contact with the first conductive portion 25 and the second conductive portion 35 in the opened state and the closed state.

Three opposed regions S1, S2 and S3 are formed as a region enclosed on at least three sides by the first conductive portion 25, the second conductive portion 35 and the third conductive portion 45 by the disposition of the third conductive portion 45B in this manner.

The operation unit side body 2B includes three power feed units 27, 31, 32 that correspond to the opposed regions S1, S2, and S3. These power feed units 27, 31, 32 are disposed between the surface on the side with the first conductive portion 25 that forms the opposed region, and are connected with the RF circuit unit 28B. The switch unit 60 is configured to enable switching the power feed unit 27 to connect in relation to either the opposed region S2 or the moveable pin 26.

The RF circuit unit 28B is connected to the control unit 50 that controls the overall operation of the cellular telephone device 1B, and executes power supply to the three opposed regions S1, S2 and S3 or the second conductive portion 35 through the power feed units 27, 31, 32 in response to a signal supplied from the control unit 50. In this configuration, the opposed regions S1, S2, and S3 formed in the opened state operate as a magnetic current antenna.

According to the fourth embodiment, the cellular telephone device 1B enables operation of the opposed regions S1, S2 and S3 as a magnetic current antenna by execution of power supply to the three opposed regions S1, S2 and S3 or to the second conductive portion 35 through the power feed units 27, 31, and 32. Therefore, the cellular telephone device 1B enables an increase in the channel number for simultaneous sending and receiving operations by use of the plurality of antennas and enables diversity applications.

Furthermore, the cellular telephone device 1B enables configuration of a plurality of antennas corresponding to the frequency in one band by adjustment of the length of the surface to which power supply to the opposed regions S1, S2 and S3 is executed. The mobile telephone apparatus 1B enables an increase in the communication capacity and application of these antennas to a multi-input multi-output (MIMO).

### Fifth Embodiment

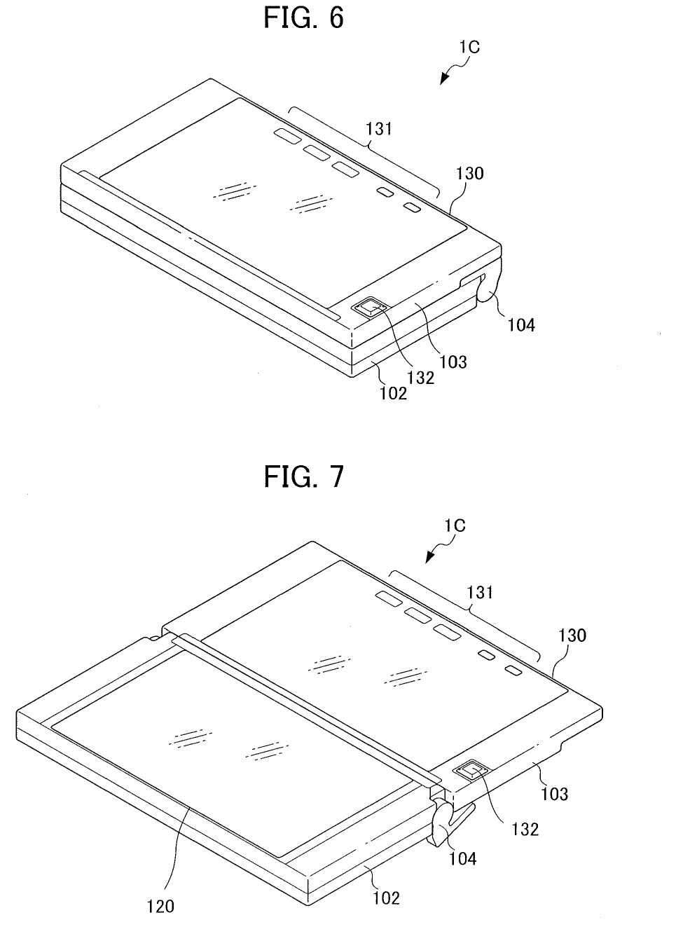

FIG. 6 and FIG. 7 are external perspective views of the cellular telephone device 1C according to the fifth embodiment.

The cellular telephone device 1C includes a first body 102 (first body), a second body 103 (second body), and a connecting portion 104 that connects the first body 102 and the second body 103.

A planar surface (surface) of the first body 102 includes a first display unit 120. A planar surface (surface) of the second body 103 includes a second display unit 130, a first operation unit 131 for operating the cellular telephone device 1C, and a second operation unit 132 used to displace a cursor displayed on the first display unit 120 and the second display unit 130. The cellular telephone device 1C can freely use the connecting portion 104 to execute a transition to a closed state in which the planar surface of the first body 102 and the lower surface of the second body 103 are opposed and disposed with reference to the direction of stacking (refer to FIG. 6) and an opened state in which the first display unit 120 on the planar surface side of the first body 120 and the second display unit 130 on the planar surface side of the second body 103 are aligned with a horizontal orientation (refer to FIG. 7).

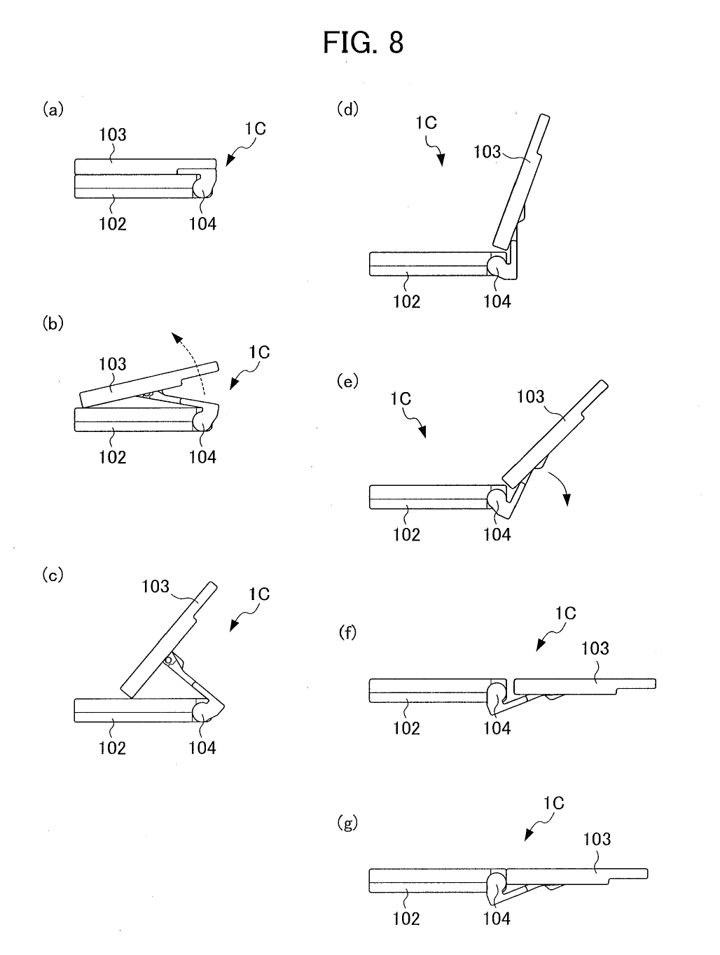

FIG. 8 describes a transition between a closed state and an opened state of the cellular telephone device 1C according to a fifth embodiment. FIG. 8(a) illustrates the cellular telephone device 1C in the closed state that enables confirmation that the second body 103 is disposed in a stacked configuration on the first body 102. FIG. 8(g) illustrates the cellular telephone device 1C in the opened state that enables confirmation that the upper surface of the first body 102 and the upper surface of the second body 103 are disposed to enable visual confirmation from the same direction. FIG. 8(b) to FIG. 8(f) illustrates an intermediate state during transition from the opened state to the closed state, or from the closed state to the opened state. The cellular telephone device 1C enables free transition between the opened state and the closed state through the state illustrated in FIG. 8(b) to FIG. 8(f) by sliding through the connecting portion 104 so that a state is maintained in which the first display unit 120 of the first body 102 and the second display unit 130 of the second body 103 are oriented and exposed in the same direction.

More specifically, the cellular telephone device 1C drives the connecting portion 104 from the closed state illustrated in FIG. 8(a) so that the second body 103 is raised in the direction of the broken-line arrow illustrated in FIG. 8 (FIG. 8(b) to FIG. 8(d)). Then, the cellular telephone device 1C adopts a configuration in which the position near the connecting portion 104 of the second body 102 in the closed state approaches a position on the opposite side of the connecting portion 104 of the first body in the closed state. Thereafter, a configuration in which the position of the second body 102 near the connecting portion 104 in the closed state and a position of the first body 102 on the opposite side of the connecting portion 104 in the closed state are maintained in proximity, and the cellular telephone device 1C is inclined towards the solid arrow illustrated in FIG. 8 (FIG. 8(e) to FIG. 8(f)), and finally executes a transition to the opened state illustrated in FIG. 8(g).

The cellular telephone device 1C is configured from other constituent elements in addition to those described above. For example, although the cellular telephone device 1C is omitted from the figures, it includes an imaging unit configured from a charge coupled device (CCD) camera, a complementary metal oxide semiconductor (CMOS) camera, or the like, a microphone for input of audio produced by a user during conversations, a speaker for output of music or the like to the outside, and the like.

The cellular telephone device 1C having the above configuration enables a configuration of a plurality of antennas using a conductive portion. The specific configuration will be described below.

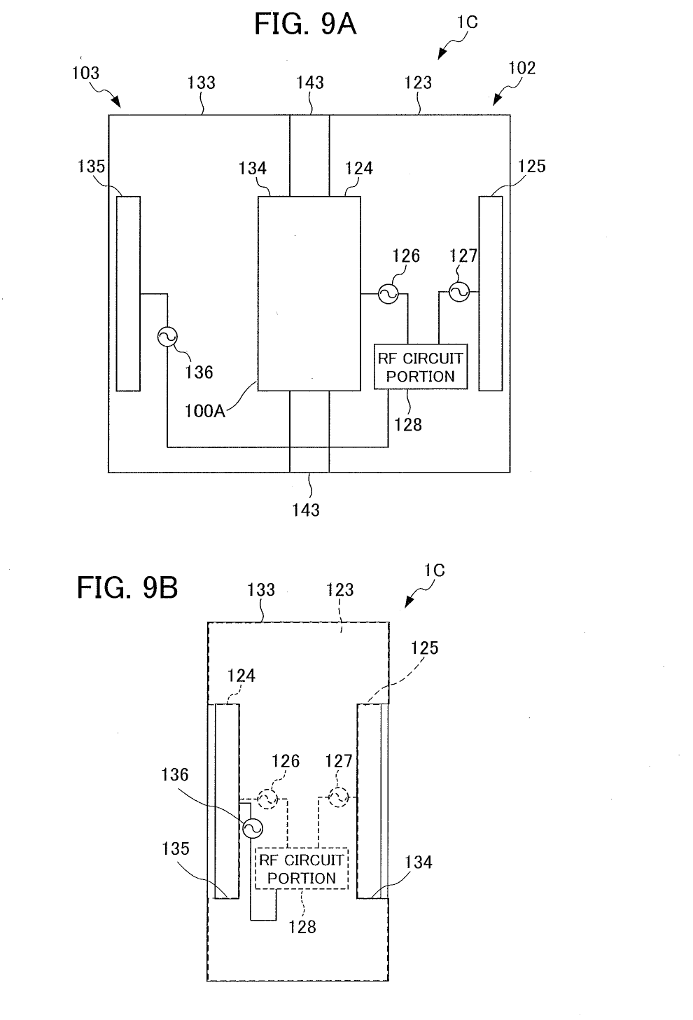

FIG. 9 is a schematic figure illustrating the internal structure of the cellular telephone device 1C according to the fifth embodiment. FIG. 9A is a schematic figure illustrating the internal structure when the cellular telephone device 1C is in the opened state. FIG. 9B is a schematic figure illustrating the internal structure when the cellular telephone device 1C is in the closed state.

As illustrated in FIG. 9, the first body 102 of the cellular telephone device 1C includes a first conductive portion 123, a first power feed unit 126 as a power feed unit, a second power feed unit 127 as a power feed unit, and an RF circuit portion 128. The second body 103 of the cellular telephone device 1C includes a second conductive portion 133 and a third feed unit 136 as a power feed unit. The connecting portion 104 of the cellular telephone device 1C includes two third conductive portions 143.

In the cellular telephone device 1C, an opposed region 100A having a predetermined spatial dimension is formed by enclosure of four sides by the first conductive portion 123, the second conductive portion 133, and the third conductive portions 143.

The first conductive portion 123 is disposed on an inner portion of the first body 102, and is configured by a tabular metal plate having a substantially rectangular parallelepiped shape and that conducts electricity. When the cellular telephone device 1C is in the opened state, the first slit 124 is formed in an elongated configuration as a first notched portion on the surface forming the opposed region 100A, that is to say, on the surface connected with the third conductive portion 143. As illustrated in FIG. 9B, the first conductive portion 123 is the end on the opposite side to the end on the side forming the opposed region 100A in the opened state. In the closed state, a first slot 125 is formed with an elongated configuration to be a second opening at a position facing the position at which a second slit 134 as described below.

The surface in the transverse direction of the first slit 124 is formed at a position which exhibits a horizontal alignment with the surface in the transverse direction of the third conductive portion 143. The longitudinal length of the first slit 124 matches the distance between the two third conductive portions 143.

The first slot 125 is formed with a size no greater than the second slit 134 described below. That is to say, the first slot 125 is formed to not overlap with the second conductive portion 133 when the cellular telephone device 1C is in the closed state. In the fifth embodiment, the longitudinal length of the first slot 125 is substantially equal to the longitudinal length of the second slit 134. However, the longitudinal length of the second slit 134 may be greater than or equal to the longitudinal length of the second slot 125. The first slot 125 can operate as a magnetic current antenna (third magnetic current antenna) without being shielded by the second conductive portion 133 when in the closed state.

The first power feed unit 126 is electrically connected with the substantially center portion in the longitudinal direction of the peripheral edge portion of the first slit 124, and is connected to the RF circuit unit 128. The first power feed portion 126 executes power supply to the first slit 124 in response to the control of the RF circuit portion 128. In this manner, when the cellular telephone device 1C is in the opened state, the opposed region 100A enclosed by the first slit 124, the second slit 134 and the third conductive portion 143 operates as a magnetic current antenna (a first magnetic current antenna).

The second power feed unit 127 is electrically connected with the substantially center portion of the longitudinal surface of the first slot 125, and is connected to the RF circuit unit 128. The second power feed portion 127 executes supply of a high frequency signal to the first slot 125 in response to the control of the RF circuit unit 128. In this manner, the first slot 125 operates as a magnetic current antenna irrespective of whether or not the cellular telephone device 1C is in an opened state or closed state.

The RF circuit unit 128 is connected to a control unit (omitted from figures) that executes overall control of the cellular telephone device 1C, and executes power supply to the first slit 124, the first slot 125 and the second slot 135 using the first power feed unit 126, the second power feed unit 127 and the third power supply unit 136 in response to supply of a signal from the control unit to thereby operate the first slit 124, the first slot 125 and the second slot 135 as a magnetic current antenna.

The second conductive portion 133 is disposed on an inner portion of the second body 103, and is configured by a tabular metal plate that has a substantially rectangular parallelepiped shape and that conducts electricity. The second slit 134 of the second conductive portion 133 is formed in an elongated configuration as a second notched portion on the surface forming the opposed region 100A when the cellular telephone device 1C is in the opened state, that is to say, on the surface connected with the third conductive portion 143. As illustrated in FIG. 9B, the second conductive portion 133 is the end on the opposite side to the end on the side forming the opposed region 100A in the opened state. The second slot 135 is formed with an elongated configuration as a first opening in the closed state at a position facing the position at which the first slit 124.

The second slit 134 is formed as a notch with a substantially equivalent size as the first slit 124. The surface in the transverse direction of the second slit 134 is formed at a position which exhibits a horizontal alignment with the surface in the transverse direction of the third conductive portion 143. That is to say, the opposed region 100A is formed as a region in the form of a substantially rectangular parallelepiped shape by enclosure by the first slit 124, the second slit 134, and the third conductive portion 143.

When the first slit 124 and the second slit 134 are operated as an antenna, the length in the longitudinal direction of the first slit 124 and the second slit 134 corresponds to the wavelength of the generated electromagnetic waves. More specifically, the longitudinal length may be nλ/2 (n=1, 2, 3, . . . ) in relation to a wave length λ corresponding to a desired resonance frequency f.

The second slot 135 is formed with a size no greater than to the first slit 124. That is to say, the second slot 135 is formed to not overlap with the first conductive portion 123 when the cellular telephone device 1C is in the closed state. In the fifth embodiment, the longitudinal length of the second slot 135 is substantially equal to the longitudinal length of the first slit 124. However, the longitudinal length of the first slit 124 may be greater than or equal to the longitudinal length of the second slot 135. Thus, the second slot 135 can operate as a magnetic current antenna (second magnetic current antenna) without being shielded by the first conductive portion 123 when in the closed state. In the fifth embodiment, the magnetic current antenna that is operated by the second slot 135 is operated in the same resonance frequency band as the magnetic current antenna that is operated by the opposed region 100A.

The third conductive portion 143 is disposed in an inner portion of the connecting portion 104, and is configured by a metal plate or the like that conducts electricity. The third conductive portion 143 is connected to the first conductive portion 123 and the second conductive portion 133. In other words, the first conductive portion 123 and the second conductive portion 133 are electrically connected through the third conductive portion 143.

The third power feed unit 136 is electrically connected with the substantially center portion in the longitudinal direction of the peripheral edge portion of the second slot 135, and is connected to the RF circuit unit 128. The third power feed portion 136 executes power supply to the second slot 135 in response to the control of the RF circuit portion 128. In this manner, the second slot 135 operates as a magnetic current antenna irrespective of whether or not the cellular telephone device 1C is in an opened state or closed state.

As described above, according to the fifth embodiment, the first conductive portion 123 and the second conductive portion 133 of the cellular telephone device 1C in the opened state are electrically connected through the third conductive portion 143. Furthermore, opposed region 100A formed by enclosure of four sides by the first conductive portion 123, the second conductive portion 133, and the third conductive portions 143 is supplied with power by the first power feed portion 126 and operated as a magnetic current antenna.

In this manner, the cellular telephone device 1C provides a novel antenna configuration using a conductive portion. Since this configuration of the portable electronic device enables use of the magnetic current antenna according to the present invention in substitution for a conventional antenna element, requirements in relation to reduction in size and thickness can be satisfied.

In this context, the cellular telephone device 1C operates the opposed region 100A formed in the opened state as a magnetic current antenna. In addition, when the first conductive portion 123 is operated as another antenna (for example, an electric current antenna), a plurality of antennas can be configured by using the conductive portion.

Furthermore, the first conductive portion 123 of the cellular telephone device 1C includes the first slit 124 on the surface forming the opposed region 100A in an opened state, and the second slot 135 is formed in the closed state at a position on the second conductive portion 133 facing the position at which the first slit 124 is formed. The second slot 135 operates as a magnetic current antenna by power supply from the third power feed unit 136 in the closed state.

In this manner, when the cellular telephone device 1C is in the opened state, the opposed region 100A is operated as a magnetic current antenna by supply of power to the opposed region 100A, and the second slot 135 is operated as a magnetic current antenna by supply of power to the second slot 135. That is to say, the cellular telephone device 1C increases the channels that can execute simultaneous sending and receiving operations, and therefore is adapted for application to diversity.

Since the second slot 135 of the cellular telephone device 1C is formed at a position facing the position at which the first slit 124 is formed, in a closed state, the polarization direction of electrical waves sent from the second slot 135 is not shielded by the first conductive portion 123. For that reason, the cellular telephone device 1C can be operated as a magnetic current antenna by power supply to the second slot 135.

Since the first slot 125 is formed at a position facing the position at which the second slit 134 is formed, even in a closed state, the polarization direction of electrical waves sent from the first slot 125 is not shielded by the second conductive portion 133, and the cellular telephone device 1C can be operated as a magnetic current antenna by power supply to the first slot 125.

Furthermore, the cellular telephone device 1C includes the second slit 134 on the second conductive portion 133 at a position facing the first slit 124 on the surface forming the opposed region 100A in an opened state, and forms the first slot 125 on the first conductive portion 123 at a position facing the position of the second slit 134 in a closed state. The first slot 125 operates as a magnetic current antenna by power supply from the first power feed unit 126 in the closed state.

In this manner, when the cellular telephone device 1C is in the opened state, the opposed region 100A is operated as a magnetic current antenna by supply of power to the opposed region 100A, and the first slot 125 and the second slot 135 are operated as a magnetic current antenna by supply of power to the first slot 125 and the second slot 135. That is to say, the cellular telephone device 1C enables a triple antenna configuration. Thus, the cellular telephone device 1C enables a further increase in the channels for simultaneous sending and receiving, increases the communication capacity, and thereby enables an improvement to communication quality.

The first slit 124 and the second slit 134 of the cellular telephone device 1C are formed as a notch with a substantially equivalent size. The second slot 135 of the cellular telephone device 1C is formed as a notch with a substantially equivalent size as the first slit 124, and the first slot 125 is formed with a substantially equivalent size to the second slit 134.

In this manner, the cellular telephone device 1C enables a configuration of a plurality of antennas corresponding to the frequency of a single band. The mobile telephone apparatus 1C enables an increase in the communication capacity and application of these antennas to a multi-input multi-output (MIMO).

Although the first conductive portion 123 has been described in relation to a metal plate, the invention is not limited in this regard. The first conductive portion may be a reference potential unit of the circuit base plate that is disposed in an inner portion of the first body 2. In this case, although the slit or the slot may be formed by formation of the circuit base plate as a physical notch, a configuration is possible in which the electrical slit or slot is formed without formation of a reference potential unit on a predetermined portion of the circuit base plate.

In the above embodiments, although a region formed by enclosure of four sides by the first conductive portion 123, the second conductive portion 133, and the third conductive portions 143 has been described as the opposed region, the invention is not limited in this regard. For example, the region may be operated as a magnetic current antenna by disposing a single third conductive portion 143 in the connecting portion 104, and supplying power to a region formed by enclosure of three sides by the first conductive portion 123, the second conductive portion 133, and the single third conductive portion 143.

In the above embodiments, although a slit and a slot are formed on both the first conductive portion 123 and the second conductive portion 133, the invention is not limited in this regard. A configuration is possible in which only the slit is formed on the first conductive portion and only the slot is formed on the second conductive portion. When the configuration of the magnetic current antenna is considered only in the opened state, a magnetic current antenna may be configured by a region formed by enclosure of at least three sides by the opposed surfaces of the first conductive portion and the second conductive portion, and the third conductive portions without formation of either the first slit or the second slit.

### Sixth Embodiment

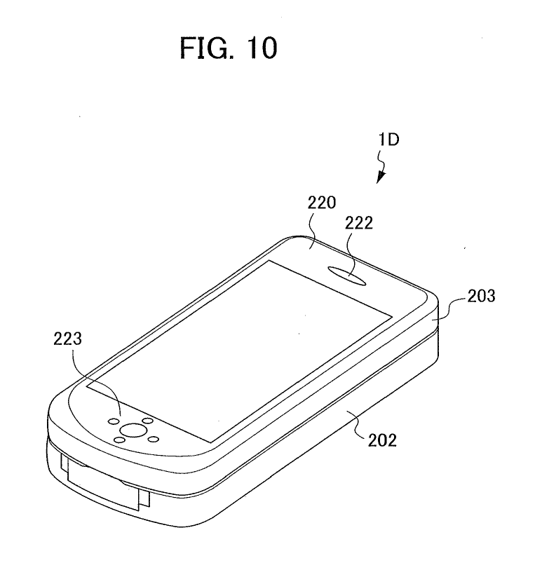

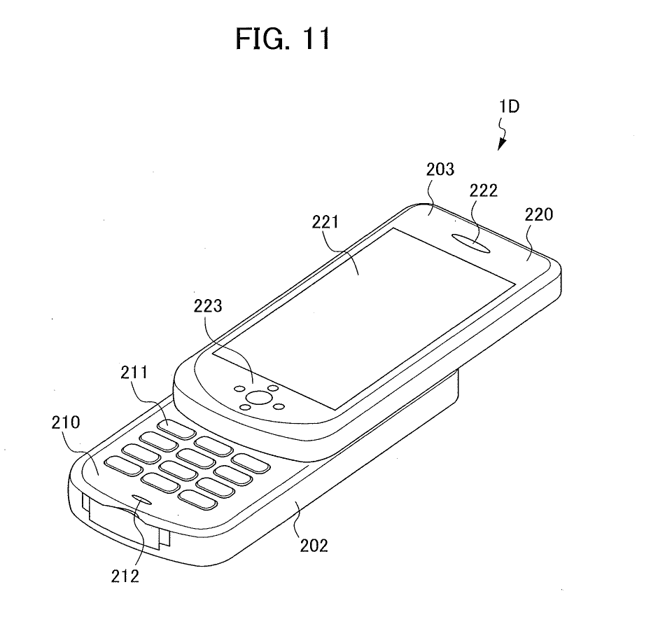

FIG. 10 and FIG. 11 are external perspective views of the cellular telephone device 1D according to a sixth embodiment.

The cellular telephone device 1D includes an operation unit side body 202 (first body) and a display unit side body 203 (second body). The surface portion 210 of the operation unit side body 202 includes an operation key set 211, and a microphone 212 for input of audio produced by a user of the cellular telephone device 1D during conversations. The operation key set 221 is configured from an input operation button for input of a character or the like such as a numeral of a telephone number, or for an email, or the like.

The surface portion 220 of the display unit side body 203 is configured from a display 221 for displaying various types of information, and audio output unit 222 for outputting of audio of conversation partner, and a determination operation button 223 for scrolling, determination or the like during various types of operations.

The cellular telephone device 1D is configured from other constituent elements in addition to the above. Other constituent elements include an imaging unit configured from a charge coupled device (CCD) camera, a complementary metal oxide semiconductor (CMOS) camera, or the like, and a speaker for output of music or the like to the outside, and the like.

The upper end of the operation unit side body 202 and the lower end of the display unit side body 203 are connected through a connecting portion 204 (not illustrated) that has a sliding mechanism. The cellular telephone device 1D can freely execute a transition to a state in which the operation unit side body 202 and the display unit side body 203 overlap, and the upper surface of the operation unit side body 202 is covered by the display unit side body 203 (a slide-down state, hereinafter referred to as an “closed state”), and a state (refer to FIG. 10) in which the display unit side body 203 slides in a longitudinal direction with respect to the operation unit side body 202, and the covered portion of the operation unit side body 202 (the operation key set 211 and the microphone 212) is exposed (a slide-up state, hereinafter referred to as an “opened state”) (refer to FIG. 11).

The cellular telephone device 1D with this configuration is configured to enable a configuration of a plurality of antennas using conductive portions. According to the above configuration, application is possible to a multi-input multi-output (MIMO) using a plurality of antennas. The specific configuration will be described below.

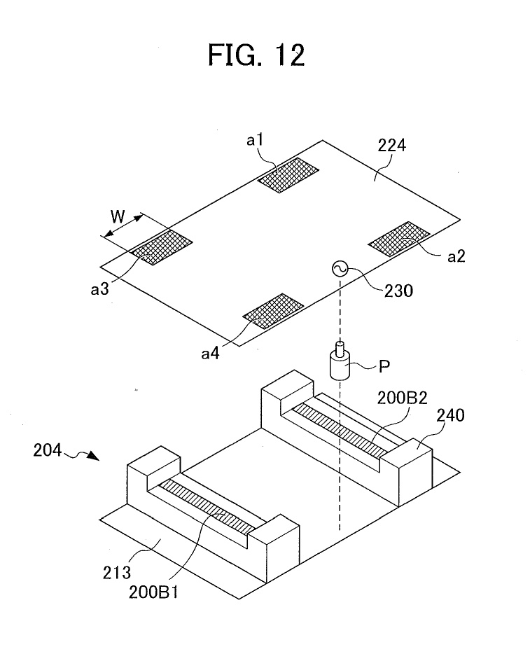

The cellular telephone device 1D includes a first power feed unit 230 as illustrated in FIG. 12. The operation unit side body 202 includes a first conductive portion 213. The display unit side body 203 includes a second conductive portion 224. The first conductive portion 213 and the display unit side body 203 are configured by a reference potential unit (ground pattern) formed on the circuit base plate. For example, the first conductive portion 213 is disposed on the key base plate that mounts the circuits or the like for processing of operating signals when the operation key set 211 is operated. Furthermore, the second conductive portion 224 is disposed on the display base plate that mounts the circuits or the like for driving of the display 221.

The connecting portion 204 includes a third conductive portion 240. The connecting portion 204 connects the operation unit side body 202 and the display unit side body 203 to enable transition from a closed state in which the planar surface of the operation unit side body 202 and the bottom surface of the display unit side body 203 are opposed and disposed in a stacking direction, and an opened state in which the operation unit side body 202 and the display unit side body 203 slide in a horizontal direction from the closed state, a portion of the planar surface of the operation unit side body 202 is exposed, and the other portion is covered by the bottom surface of the display unit side body 203. The third conductive portion 240 is configured by a reference potential unit (ground pattern) formed on the connecting portion 204. The third conductive portion 240 corresponds, for example, to a metallic rail disposed on the connecting portion 204.

A magnetic current antenna is configured by the portion that is disposed and stacked in both the opened state and the closed state of the operation unit side body 202 and the display unit side body 203 in the cellular telephone device 1D. As illustrated in FIG. 12, the operation unit side body 202 and the display unit side body 203 executes a transition between an opened state and a closed state within the range of W. The first conductive portion 213 and the second conductive portion 224 are electrically conductive via the connecting portion 204 and the third conductive portion 240 in the regions a1, a2, a3 and a4 in FIG. 12 in the opened state and the closed state.

200B1 and 200B2 in FIG. 12 denote a slit for a signal line.

In the opened state and the closed state, the first conductive portion 213 and the second conductive portion 224 are electrically connected through the third conductive portion 240. Furthermore, the opposed region 200A is formed by enclosure of at least three sides by the first conductive portion 213, the second conductive portion 224 and the third conductive portion 240. The opposed region 200A operates as a magnetic current antenna by supply of power from the first power feed portion 230. The first power feed unit 230 is disposed on the edge (transverse end) of the second conductive portion 224, and is placed in contact by a spring pin (a probe pin that is compressible by bending of the distal end) P that is disposed on the first conductive portion 213. The first power feed unit 230 is connected through the spring pin P, for example, to a processing unit (not illustrated) that processes the high frequency signal provided on the circuit base plate (not illustrated) disposed on the operation unit side body 202 or the display unit side body 203.

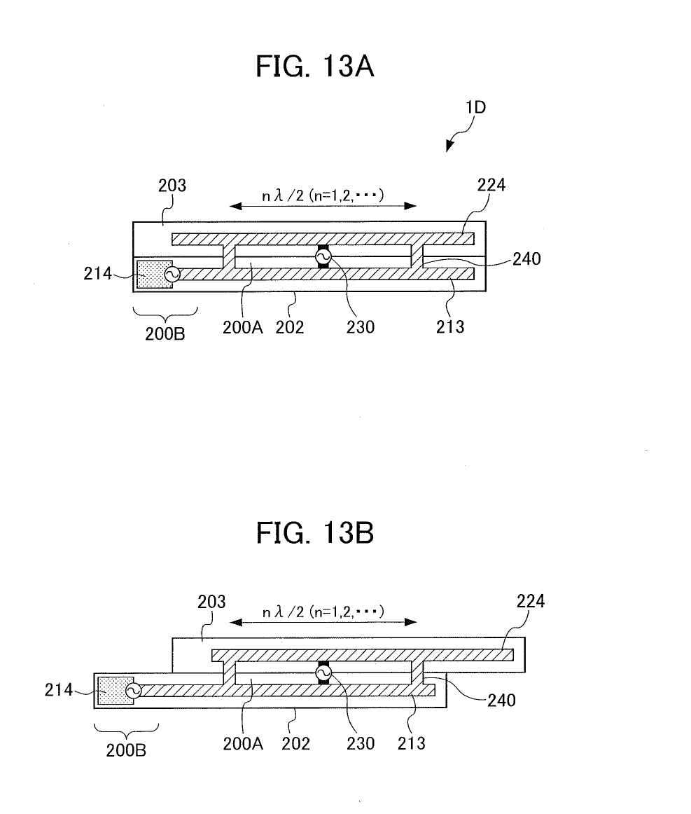

More specifically, as illustrated in FIG. 13A and FIG. 13B, in the closed state and the opened state, a magnetic current antenna (slot antenna) is configured by power supply from the first power feed unit 230 to the opposed region 200A formed by enclosure by the first conductive portion 213, the second conductive portion 224 and the third conductive portion 240. Furthermore the antenna (monopole antenna) 214 is connected to one end 200B of the first conductive portion 213.

The polarization surface of the magnetic current antenna and the antenna 214 are mutually orthogonal. The antenna 214 is termed an electric current antenna and exhibits a different radiation pattern from a magnetic current antenna. The cellular telephone device 1D enables operation of the magnetic current antenna and the antenna 214 that exhibit a mutually low correlation while realizing high isolation in either a closed state or an opened state.

A signal having a frequency that corresponds to the longitudinal length of the slot can be sent and received by the magnetic current antenna. More specifically, the longitudinal length of the slot is determined by nλ/2 (wherein, n=1, 2, 3, . . . ) in relation to a desired wave length λ.

In the above embodiments, although both ends of the first conductive portion 213 and the second conductive portion 224 are connected by the third conductive portions 240 to thereby form the opposed region 200A enclosed on four sides, the invention is not limited in this respect.

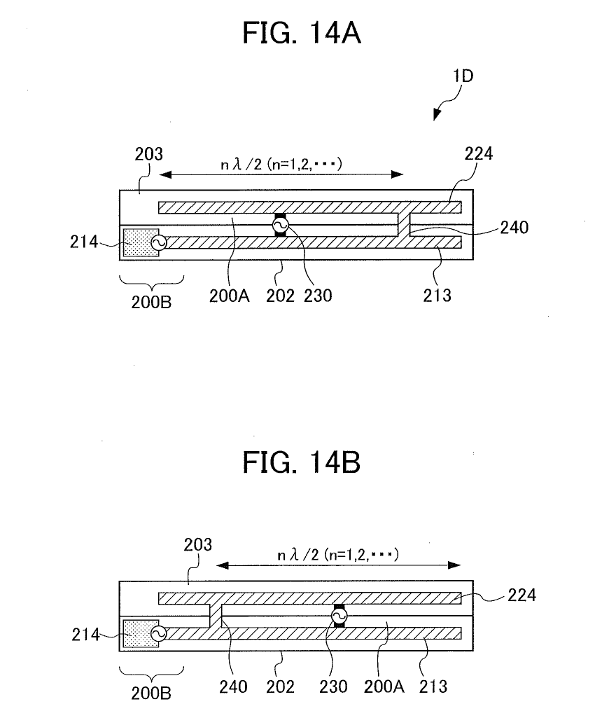

For example, as illustrated in FIG. 14A and FIG. 14B, only one end of the first conductive portion 213 and the second conductive portion 224 may be connected by the third conductive portion 240 to thereby form the opposed region 200A enclosed on three sides by the first conductive portion 213, the second conductive portion 224 and the third conductive portion 240. The opposed region 200A can be operated as a magnetic current antenna by supply of power from a first power feed portion 230 to the opposed region 200A.

As illustrated in FIG. 14A, the position at which the third conductive portion 240 is disposed may be a position in proximity to the antenna 214, or as illustrated in FIG. 14B may be a position separated from the antenna 214. In FIG. 14A and FIG. 14B, although the first power feed unit 230 is disposed at a substantially central position in the longitudinal direction of the slot, the invention is not limited in this respect.

Since the magnetic current antenna illustrated in FIG. 14A and FIG. 14B exhibits a longer longitudinal slot length in comparison to the magnetic current antenna configured as illustrated in FIG. 13A and FIG. 13B, a signal having a low frequency (long wave length) may be sent and received.

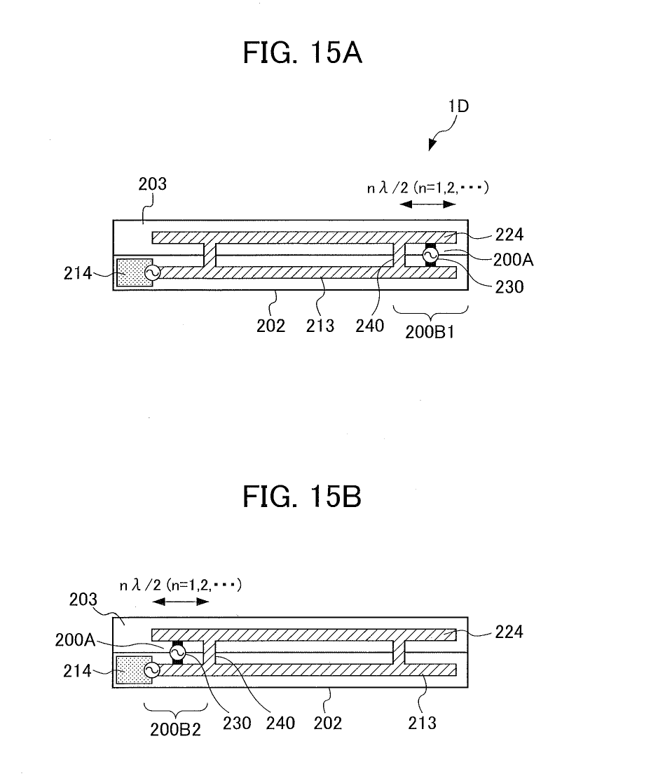

In another embodiment, as illustrated in FIG. 15A and FIG. 15B, the opposed region 200A may be operated as a magnetic current antenna by supply of current from the first current feed unit 230 to the opposed region 200A that is formed by enclosure of three sides at the end of the first conductive portion 213 and the second conductive portion 224. The opposed region 200A may be formed on one end 200B1 of the first conductive portion 213 (refer to FIG. 15A), or may be formed on the other end 200B2 of the first conductive portion 213 (refer to FIG. 15B).

Sending and receiving high frequency (short wave length) signals is possible since the magnetic current antenna having the configuration illustrated in FIG. 15 has a lower longitudinal slot length when compared with the magnetic current antenna having the configuration illustrated in FIG. 13 and FIG. 14.

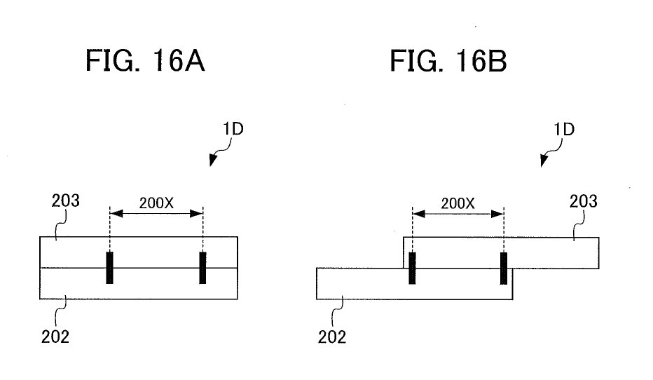

In this manner, the magnetic current antenna of the cellular telephone device 1D is configured by a portion (200X in FIG. 16A and FIG. 16B) in which the operation unit side body 202 and the display unit side body 203 are disposed in a stacked configuration in both the opened state and the closed state. Consequently, the cellular telephone device 1D configures an antenna (slot antenna) that uses a conductive portion (first conductive portion 213, second conductive portion 224 and third conductive portion 240) in the opened state and the closed state. In this manner, since the cellular telephone device 1D realizes high isolation and low correlation with other antennas (for example, the antenna 214), a plurality of antennas can be operated simultaneously without a reduction in gain.

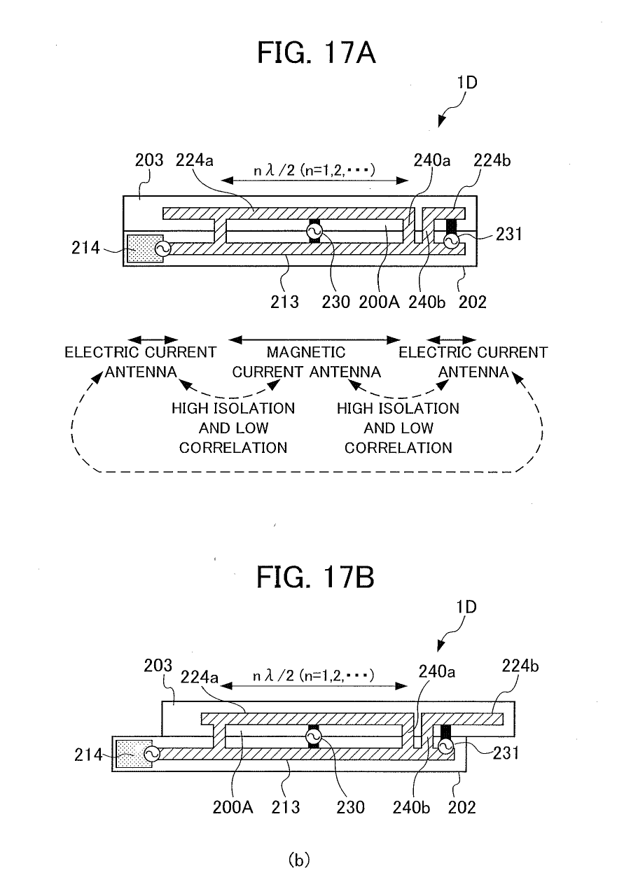

The cellular telephone device 1D may be further provided with a second power feed unit 231 as illustrated in FIG. 17A and FIG. 17B. The second conductive portion 224 includes a first unit 224a and a second unit 224b. The third conductive portion 240 includes a first unit 240a and a second unit 240b.

In a closed state and an opened state, the first unit 224a that configures the first conductive portion 213 and the second conductive portion 224 are electrically connected through the first unit 240a that configures the third conductive portion 240. In this case, the opposed region 200A is formed by enclosure with the first conductive portion 213, the first unit 224a that configures the second conductive portion 224, and the first unit 240a that configures the third conductive portion 240. The opposed region 200A operates as a magnetic current antenna by supply of power from the first supply unit 230.

Furthermore, the first conductive portion 213 and the second unit 224b that configures the second conductive portion 224 are electrically connected through the second portion 240b that configures the third conductive portion 240. In this case, the second unit 224b that configures the second conductive portion 224 operates as an inverted F antenna by power supply from the second power feed unit 231.

In the opened state and the closed state, an antenna is formed in the cellular telephone device 1D that uses a conductive portion (the first conductive portion 213, the first unit 224a that configures the second conductive portion 224, and the first unit 240a that configures the third conductive portion 240), and an inverted F antenna is formed by the first conductive portion 213, the second unit 224b that configures the second conductive portion 224, and the second unit 240b that configures the third conductive portion 240. Furthermore, the cellular telephone device 1D includes an antenna 214 (electric current antenna) on the end on which the inverted F antenna is not formed.

In this manner, simultaneous operation is enabled without a reduction in gain since the cellular telephone device 1D enables high isolation between the low-correlation slot antenna and the inverted F antenna.

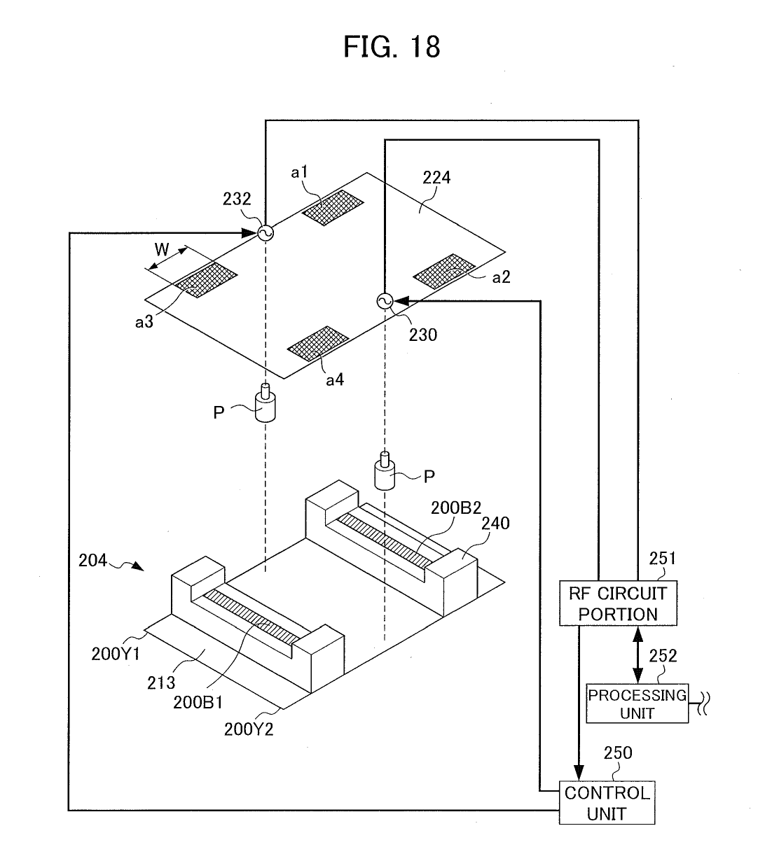

As illustrated in FIG. 18, the cellular telephone device 1D includes a third power feed unit 232 and a control unit 250. The third power feed unit 232 operates the first conductive portion 213 of the opposed region 200A and one end 200Y1 in the transverse direction of the second conductive portion 224 as a first magnetic current antenna. The control unit 250 switches the operation of the first power feed unit 230 and the third power feed unit 232. The first power feed unit 230 operates the first conductive portion 213 of the opposed region 200A and the other end 200Y2 in the transverse direction of the second conductive portion 224 as a second magnetic current antenna. The control unit 250 switches the first power feed unit 230 or the third power feed unit 232 to an operating state so that communication is executed by the magnetic current antenna that has a high communication quality in comparison to the communication quality of the first magnetic current antenna or the communication quality of the second magnetic current antenna.

The first power feed portion 230 sends a signal received from the first magnetic current antenna to the RF circuit portion 251 in accordance with the control of the control unit 250. The first power feed portion 230 sends a signal processed by the RF circuit unit 251 to the first magnetic current antenna. The RF circuit unit 251 executes a predetermined signal processing on the signal (high frequency signal) that was sent through the first power feed unit 230, and sends the signal to the processing unit 252. The RF circuit unit 251 executes predetermined signal processing on the signal that was sent from the processing unit 252, and sends the processed signal (high frequency signal) to the first power feed unit 230.

The third power feed unit 232 sends a signal received from the second magnetic current antenna to the RF circuit portion 251 in accordance with the control of the control unit 250. The third power feed portion 232 sends a signal processed by the RF circuit unit 251 to the second magnetic current antenna. The RF circuit unit 251 executes a predetermined signal processing on the signal (high frequency signal) that was sent through the third power feed unit 232, and sends the signal to the processing unit 252. The RF circuit unit 251 executes predetermined signal processing on the signal that was sent from the processing unit 252, and sends the processed signal (high frequency signal) to the third power feed unit 232.

In this context, the control unit 250 controls the operating state of the first power feed unit 230 and detects a communication sensitivity with the first magnetic current antenna based on the results of the signal processing in the RE circuit unit 251. Thereafter, the control unit 250 control the first power feed unit 230 to a non-operating state and controls the third power feed unit 232 to an operating state. The control unit 250 detects a communication sensitivity with the second magnetic current antenna based on the results of the signal processing in the RE circuit unit 251. Then, the control unit 250 compares the respective communication sensitivities, and switches one of the first power feed unit 230 or the third power feed unit 232 to an operating state to prioritize continuation of communication using the magnetic current antenna on the side with superior communication sensitivity.

The control unit 250 may detect the communication sensitivity by use of received signal strength indication (RSSI) as received by the respective antennas. Furthermore, the control unit 250 may operate both the first power feed unit 230 and the third power feed unit 232, and may execute communication with the antenna of the first magnetic current antenna and the second magnetic current antenna that exhibits superior communication quality and intermittently receive a signal with the other antenna.

In this manner, in either of the opened state or the closed state, a so-called diversity antenna is configured by operating two magnetic current antennas and prioritizing use of the antenna exhibiting superior communication quality.

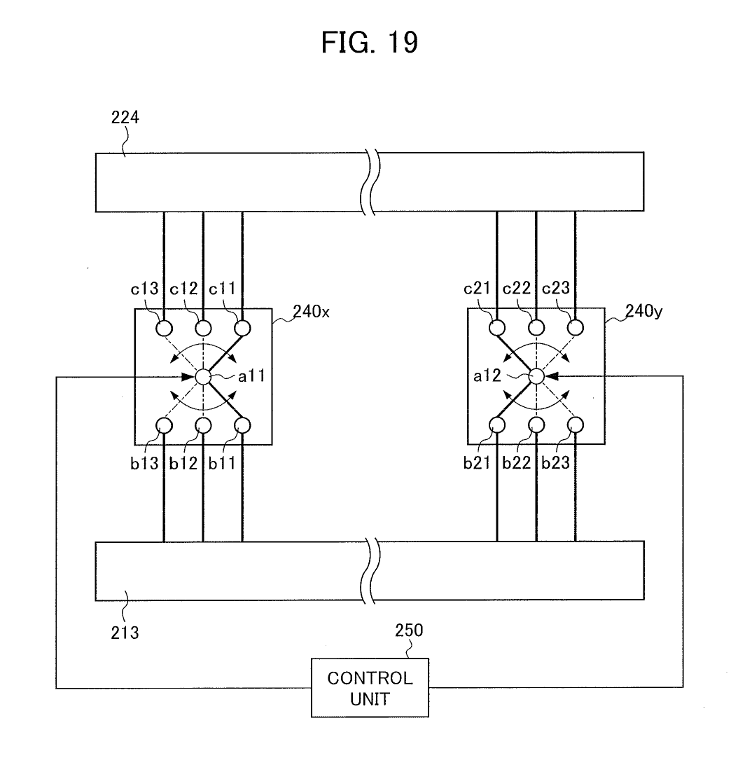

The cellular telephone device 1D according to the sixth embodiment may have a different configuration to that described above. For example, as illustrated in FIG. 19, the third conductive portion 250 of the cellular telephone device 1D may be configured from a first switching unit 240x and a second switching unit 240y. Switching operations in relation to the switches may be configured to be controlled by control from the control unit 250. The power feed unit is omitted from FIG. 19.

The first switching unit 240x is configured from a switching terminal a11, terminals b11, b12, b13 connected to the first conductive portion 213, and terminals c11, c12, c13 connected to the second conductive portion 224.

The second switching unit 240y is configured from a switching terminal a21, terminals b21, b22, b23 connected to the first conductive portion 213, and terminals c21, c22, c23 connected to the second conductive portion 224.

When executing communication in a high frequency band, the control unit 250 controls the switching terminal all of the first switching unit 240x to make contact with the terminal b11 and the terminal c11, and controls the switching terminal a21 of the first switching unit 240y to make contact with the terminal b21 and the terminal c21. This switching configuration enables adjustment of the longitudinal slot length of the cellular telephone device 1D to a relatively short value and execution of high frequency communication.

When executing communication in a low frequency band, the control unit 250 controls the switching terminal all of the first switching unit 240x to make contact with the terminal b13 and the terminal c13, and controls the switching terminal a21 of the second switching unit 240y to make contact with the terminal b23 and the terminal c23. This switching configuration enables the cellular telephone device 1D to adjust the longitudinal slot length to a relatively long value and execute low frequency communication.

When executing communication in a frequency band between a high frequency band and a low frequency band, the control unit 250 controls the switching terminal all of the first switching unit 240x to make contact with the terminal b12 and the terminal c12, and controls the switching terminal a21 of the second switching unit 240y to make contact with the terminal b22 and the terminal c22. This switching configuration enables the cellular telephone device 1D to adjust the longitudinal slot length to a predetermined value and execute communication at an intermediate frequency.

Next, the length of the wavelength (λ/2) that enables communication (longitudinal slot length) will be described in relation to a representative frequency. A frequency of 800 MHz-900 MHz for code division multiple access (CDMA) is approximately 167 to 187 mm, a frequency of 1700 MHz-1900 MHz (CDMA) is approximately 79 to 88 mm, a frequency of 2.4 Hz-2.5 GHz (WLAN) is approximately 60 to 62 mm, a frequency of 2.5 GHz-2.6 GHz (WiMAX) is approximately 58 to 62 mm, and a frequency of 5 GHz (WLAN) is approximately 30 mm. The longitudinal slot length described above is measured in a vacuum and differs from the actual value.

### Seventh Embodiment

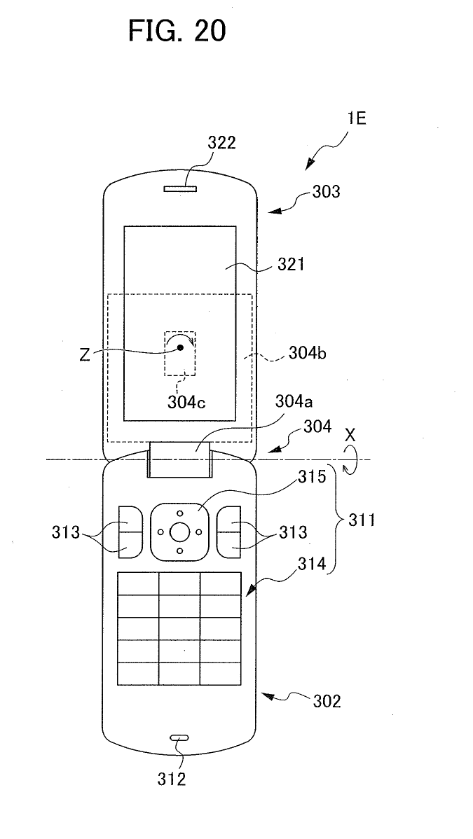

FIG. 20 illustrates the external appearance of a cellular telephone device 1E according to a seventh embodiment.

As illustrated in FIG. 20, the cellular telephone device 1E includes an operating unit side body 302 as a first body and a display unit side body 303 as a second body.

The outer surface of the operating unit side body 302 is configured by a front case and a rear case. The operating unit side body 302 is configured so that an operation key set 311, and a microphone 312 for input of audio produced by a user of the cellular telephone device 1D during conversations are respectively exposed.

The operation key set 311 is configured from a function setting operation key 313 for operating various settings or various functions such as an address book function, an email function, or the like, an input operation key 314 for input of a numeral of a telephone number, or character for an email, or the like, and a determination operation key 315 acting as an operation member for scrolling up and down or right and left, or determination of various types of operations, or the like. The respective keys configuring the operation key set 311 are allocated with predetermined functions in response to a type of mode or an opened or closed state of the operation unit side body 302 and the display unit side body 303, or a type of activated application, or the like. An operation corresponding to a function allocated to a key is executed by a user pressing respective keys.

The external surface of the display unit side body 303 is configured by a front case and a rear case. The front case of the display unit side body 303 is configured to dispose and expose the display unit 321 for displaying various types of information and an audio output unit 322 as a receiver for outputting of audio of conversation partner.

The operation unit side body 302 and the display unit side body 303 are connected to open and close through the connecting portion 304. More specifically, the connecting portion 304 includes a hinge mechanism 304a, a supporting portion 304b and a rotating mechanism 304c.

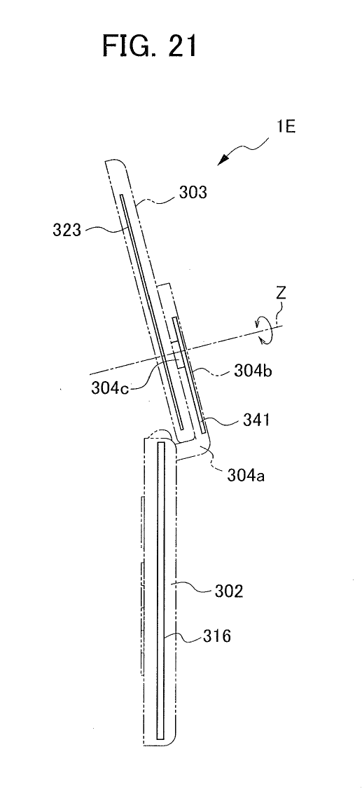

As illustrated in FIG. 21, the supporting portion 304b and the end near to the connecting portion 304 in the operation unit side body 302 are connected through the hinge mechanism 304a. The display unit side body 303 and the hinge mechanism 304a are connected through the supporting portion 304b. The supporting portion 304b and the display unit side body 303 are connected through a rotating mechanism 304c. In this manner, the cellular telephone device 1E connects the operation unit side body 302 and the display unit side body 303 through the hinge mechanism 304a, the supporting portion 304 and the rotating mechanism 304c, and thereby executes relative movement of the operation unit side body 302 and the display unit side body 303. Furthermore, the cellular telephone device 1E enables relative movement of the display unit side body 303 and the supporting portion 304b.

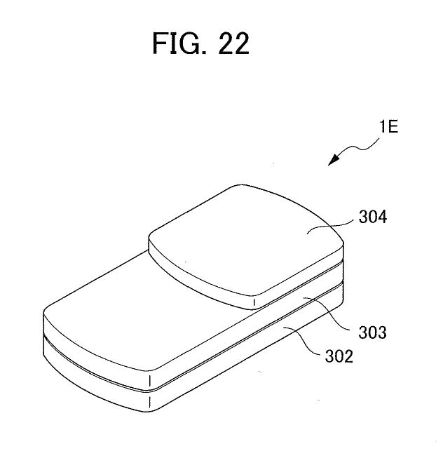

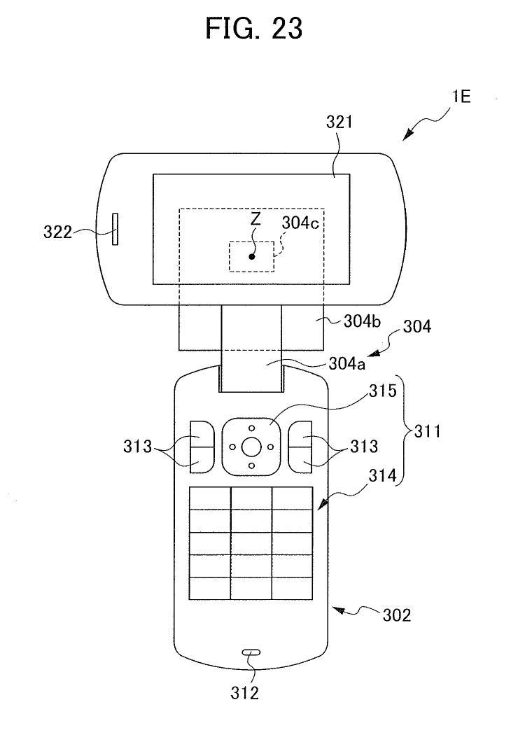

The cellular telephone device 1E can use the connecting portion 304 to adopt a closed state (refer to FIG. 22), a first opened state (refer to FIG. 20) and a second opened state (refer to FIG. 23). The closed state is a state in which the principal surface (planar surface) of the operation unit side body 302 is opposed to the principal surface of the display unit side body 303 in a stacked configuration. The first opened state is a state in which the hinge mechanism 304a is operated, and the operation unit side body 302 is rotated by a predetermined angle in relation to the display unit side body 303 about a first rotation axis (X in FIG. 20) enabling rotation from the closed state in the first direction, and thereby exposes the principal surface of the operation unit side body 302 and the principal surface of the display unit side body 303 to be visible from the same direction. The second opened state is a state in which the rotating mechanism 304c is operated, and the display unit side body 303 is rotated by a predetermined angle (for example, substantially 90 degrees) in a planar direction about a second rotation axis (Z in FIG. 20) enabling rotation from the first opened state in the second direction that is orthogonally disposed in relation to the first direction, with the principal surface of the operation unit side body 302 and the principal surface of the display unit side body 303 still visible from the same direction.

The cellular telephone device 1E that is configured in this manner can configure a plurality of antennas that uses a conductive portion. The above configuration enables application of a plurality of antennas to a multi-input multi-output (MIMO). The specific configuration will be described below.

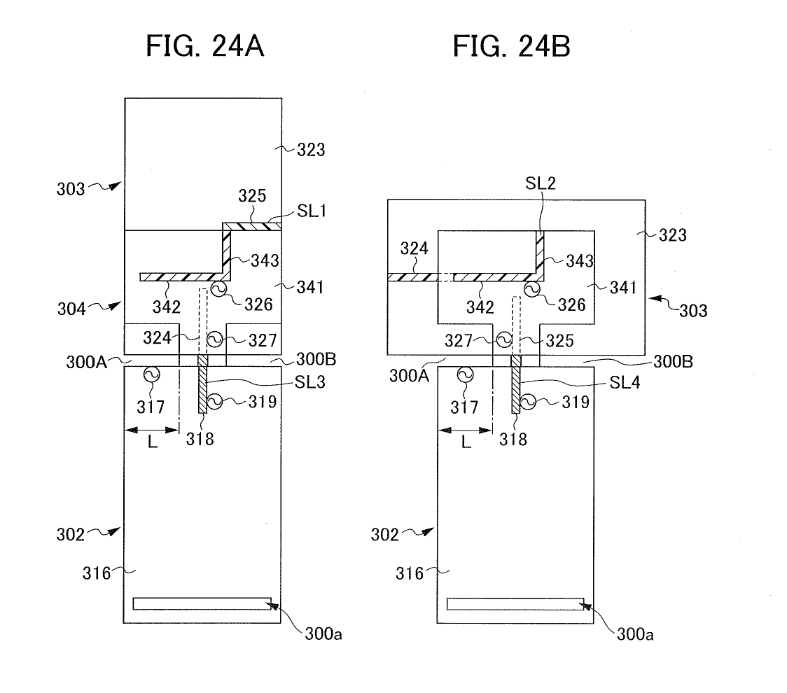

As illustrated in FIG. 24, the cellular telephone device 1E includes the operation unit side body 302 that has a first conductive portion 316, the display unit side body 303 that has a second conductive portion 323, and a third conductive portion 341. The cellular telephone device 1E includes a power feed unit 317 and a connecting portion 304 that connects the operation unit side body 302 and the display unit side body 303 so that the closed state, the first opened state and the second opened state as described above can be adopted.

The first conductive portion 316 and the second conductive portion 323 are configured by a reference potential unit (ground pattern) that is formed on the circuit base plate. For example, the first conductive portion 316 is disposed on a key base plate that mounts the circuits or the like that process an operation signal when the operation key set 311 is operated. Furthermore, the second conductive portion 323 for example is disposed on the display unit base plate that mounts the circuits or the like that drive the display unit 321. The third conductive portion 341 is configured by a reference potential unit (ground pattern) that forms the connecting portion 304.

When the cellular telephone device 1E is in the first opened state (refer to FIG. 24A), the first conductive portion 316 and the second conductive portion 323 are electrically connected through the third conductive portion 341. An opposed region A (A in FIG. 24A) that is formed by enclosure of at least three sides by the first conductive portion 316, the second conductive portion 323 and the third conductive portion 341 is supplied with power from the power feed unit 317 to thereby operate as a magnetic current antenna (slot antenna).

When the cellular telephone device 1E is in the second opened state (refer to FIG. 24B), the first conductive portion 316 and the second conductive portion 323 are electrically connected through the third conductive portion 341. An opposed region 300A (300A in FIG. 24B) that is formed by enclosure of at least three sides by the first conductive portion 316, the second conductive portion 323 and the third conductive portion 341 is supplied with power from the power feed unit 317 to thereby operate as a magnetic current antenna (slot antenna).

The power feed unit 317 is connected to a processing unit (not illustrated) for processing of a high frequency signal and is mounted on the key base plate. The magnetic current antenna enables sending and receiving of signals having a frequency corresponding to the longitudinal slot length. More specifically, the longitudinal slot length is determined by nλ/2 (wherein, n=1, 2, 3, . . . ) in relation to a desired wave length λ. Since the length of the first conductive portion 316 that forms the opposed region 300A (L in FIG. 24A and FIG. 24B) in the cellular telephone device 1E does not vary in either the first opened state or the second opened state, communication can be executed with a signal having the same frequency in either state.

In this manner, in either the first opened state or the second opened state, the opposed region 300A that is formed by enclosure of at least three sides by the first conductive portion 316, the second conductive portion 323 and the third conductive portion 341 is supplied with power from the power feed unit 317 to thereby operate as a magnetic current antenna.

An antenna 300a (monopole antenna) is connected to one end of the first conductive portion 316.

The polarization surface of the magnetic current antenna and the antenna 300a are mutually orthogonal. The antenna 300a is termed an electric current antenna and exhibits a different radiation pattern from a magnetic current antenna. The cellular telephone device 1E enables operation of the magnetic current antenna and the antenna 300a that exhibit low correlation for the purpose of high isolation in the closed state, the first opened state and the second opened state.

As illustrated in FIG. 24A and FIG. 24B, since the two opposed regions are formed (the “opposed region 300A” and the “opposed region 300B” in FIG. 24A and FIG. 24B), operation as a magnetic current antenna is possible by supply of power by the power feed unit to the respective opposed regions. In this configuration, a so-called diversity antenna is configured by operating two magnetic current antennas and prioritizing use of the antenna exhibiting superior communication quality.

The cellular telephone device 1E may enable a function as a magnetic current antenna by provision of respective slits in the first conductive portion 316, the second conductive portion 323 and the third conductive portion 341 (a conductive portion including a cut or notch of a predetermined shape, in which the periphery thereof is enclosed by the reference potential unit, and has the same definition as the slot), and then supply of power by a power feed unit to the slit. The specific configuration will be described below.

As illustrated in FIG. 24A and FIG. 24B, in the second conductive portion 323, a first slit 324 having a predetermined shape is formed in an end facing the connecting portion 304 in the first opened state, and a second slit 325 having a predetermined shape is formed in an end facing the connecting portion 304 in the second opened state. An imaginary line assuming extension of the first slit 324 in the longitudinal direction of the second conductive portion 323 and an imaginary line assuming extension of the second slit 325 in the transverse direction of the second conductive portion 323 intersect at the predetermined angle (for example, approximately 90 degrees) as described above.

In the third conductive portion 341, a third slit 342 with a predetermined shape is formed in the longitudinal direction, and a fourth slit 343 with a predetermined shape is formed in the transverse direction. One end of the third slit 342 and one end of the fourth slit 343 are integrally formed by joining. The third slit 342 and the fourth slit 343 intersect at the predetermined angle (for example, approximately 90 degrees) as described above.

When the cellular telephone device 1E has executed a transition to the first opened state, the second slit 325, the third slit 342 and the fourth slit 343 form an integrated slit SL1 by joining of one end of the second slit 325 with the other end of the fourth slit 343, and are operated as a magnetic current antenna by power supply from the power feed unit 326 (refer to FIG. 24A). The first slit 324 can operate as a magnetic current antenna by supply of power from the power feed unit 327 to the first slit 324.

When the cellular telephone device 1E has executed a transition to the second opened state, the first slit 324, the third slit 342 and the fourth slit 343 form an integrated slit SL2 by joining of one end of the first slit 324 with the other end of the third slit 342, and are operated as a magnetic current antenna by power supply from the power feed unit 326 (refer to FIG. 24B). The second slit 325 can operate as a magnetic current antenna by supply of power from the power feed unit 327 to the second slit 325.

The formation of the first slit 324 and the second slit 325 in the cellular telephone device 1E with substantially the same length enables the slit SL1 formed in the first opened state and the slit SL2 formed in the second opened state to have the same length (but different shape) and therefore enables execution of communication by signals of the same frequency in either state. In this configuration, the frequency used by the first slit 324 that is operated as a magnetic current antenna in the first opened state is the same frequency as the frequency used by the second slit 325 that is operated as a magnetic current antenna in the second opened state.

The first conductive portion 316 may form a fifth slit 318 with a predetermined shape on the end facing the connecting portion 304. In this configuration, when the cellular telephone device 1E executes a transition to the first opened state, the first slit 324 and the fifth slit 318 form an integrated slit SL3 by joining of the ends, and operate as a magnetic current antenna by power supply from the power feed unit 319 (refer to FIG. 24A).

Furthermore, when the cellular telephone device 1E executes a transition to the second opened state, the second slit 325 and the fifth slit 318 form an integrated slit SL4 by joining of the ends, and operate as a magnetic current antenna by power supply from the power feed unit 319 (refer to FIG. 24A). The slit SL3 formed in the first opened state and the slit SL4 formed in the second opened state may be supplied with power from the power feed unit 327 rather than the power feed unit 319.

The integrated slit SL1 and slit SL3 of the cellular telephone device 1E formed in the first opened state have different slit lengths and therefore can be adapted to a plurality of wavelengths. The integrated slit SL2 and slit SL4 of the cellular telephone device 1E formed in the second opened state have different slit lengths and therefore can be adapted to a plurality of wavelengths.

Next, the relationship between the lengths of each slit will be described. The length of the fifth slit 318 is half the length of the wavelength λ of a desired frequency (λ/2). The length of the integrated slit SL3 formed by joining the fifth slit 318 and the first slit 324 is (λ/2)×n (wherein, n=1, 2, 3, . . . ). The length of the integrated slit SL4 formed by joining the fifth slit 318 and the second slit 325 is (λ/2)×n (wherein, n=1, 2, 3, . . . ). The first slit 324 and the second slit 325 have the same length. However, the length of the slit is greater than the width of the slit.

In this configuration, the integrally joined slit SL3 and the slit SL4 of the cellular telephone device 1E have the same length in the first opened state and the second opened state, and therefore enable communication at the same frequency.

The length of the integrated slit SL1 formed by joining the second slit 325, the third slit 432, and the fourth slit 343 is (λ/2)×n (wherein, n=1, 2, 3, . . . ), and the length of the integrated slit SL2 formed by joining the first slit 324, the third slit 432 and the fourth slit 343 is (λ/2)×n (wherein, n=1, 2, 3, . . . ).

In this configuration, the integrally joined slit SL1 and the slit SL2 of the cellular telephone device 1E have the same length in the first opened state and the second opened state, and therefore enable communication at the same frequency. Since the fifth slit 318 is formed in the longitudinal direction of the first conductive portion 316, and the first slit 324 is formed in the longitudinal direction of the second conductive portion 323, both are stacked with respect to the direction of stacking of the operation unit side body 302 and the display unit side body 303 when the cellular telephone device 1E is in the closed state. Even when the first slit 324 or the fifth slit 318 are operated in the closed state as a magnetic current antenna, radiation of electromagnetic waves from the other is not covered.

The connection of the slits formed in different conductive portions will be described. For example, a method has been considered of configuring the connecting portion 304 as a metallic hinge to create an electrical connection between the slit on the first conductive portion 316 (fifth slit 318) and the slit on the second conductive portion 323 (the first slit 324 and the second slit 325) in the first opened state and the second opened state.

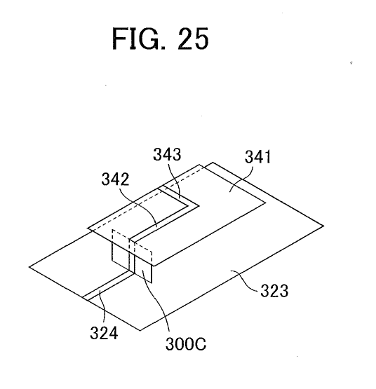

As illustrated in FIG. 25, a method is also possible in which the connection between the second conductive portion 323 and the third conductive portion 341 is formed between respectively disposed base plate GND (reference potential portion) by use of a portion of an inserted metal plate, or a conductive material 300C.

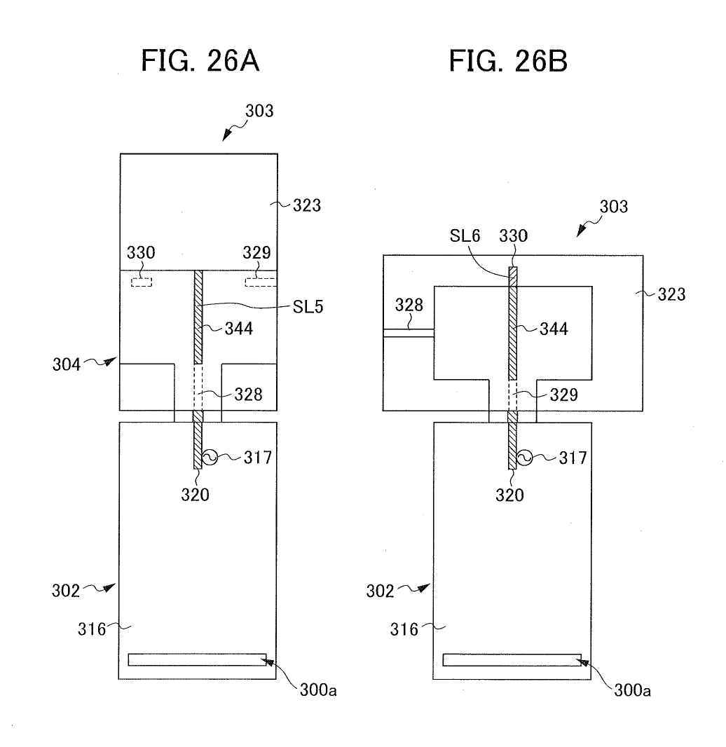

As illustrated in FIG. 26A or FIG. 26B, the first conductive portion 316 in the cellular telephone device 1E may form a sixth slit 320 having a predetermined shape on the end facing the connecting portion 304. The second conductive portion 323 includes a seventh slit 328 having a predetermined shape on the end facing the connecting portion 304 in the first opened state, an eighth slit 329 having a predetermined shape on the end facing the connecting portion 304 in the second opened state, and a ninth slit 330 having a predetermined shape on line of extension of the eighth slit 329. The third conductive portion 341 includes a tenth slit 344 having a predetermined shape in a longitudinal direction.

In this configuration, the sixth slit 320, the seventh slit 328 and the tenth slit 344 form an integrated slit SL5 by joining of the ends in the first opened state, and operate as a magnetic current antenna by power supply from the power feed unit 317 (refer to FIG. 26A).

Furthermore, the sixth slit 320, the eighth slit 329, the ninth slit 330 and the tenth slit 344 form an integrated slit SL6 by joining of the ends in the second opened state, and operate as a magnetic current antenna by power supply from the power feed unit 317 (refer to FIG. 26B).

The length of the seventh slit 328 may be formed to correspond to the length obtained by adding the eighth slit 329 and the ninth slit 330. This configuration enables the slit SL5 that is integrally formed in the first opened state (the slit formed by joining of the sixth slit 320, the seventh slit 328 and the tenth slit 344) and the slit SL6 that is formed in the second opened state (the slit formed by joining of the sixth slit 320, the eighth slit 329, the ninth slit 330, and the tenth slit 344) to have the same length, and therefore enables execution of communication by signals of the same frequency in either state.

Furthermore, the cellular telephone device 1E may be supplied with power from respective power feed units (not illustrated) in relation to the eighth slit 329 and the ninth slit 330 in the first opened state. In this configuration, the cellular telephone device 1E can operate a plurality of independent magnetic current antennas in the first opened state.

The cellular telephone device 1E may be supplied with power from a power feed unit (not illustrated) in relation to the seventh slit 328 in the second opened state. In this configuration, the cellular telephone device 1E can also operate a plurality of independent magnetic current antennas in the second opened state.

### Eighth Embodiment

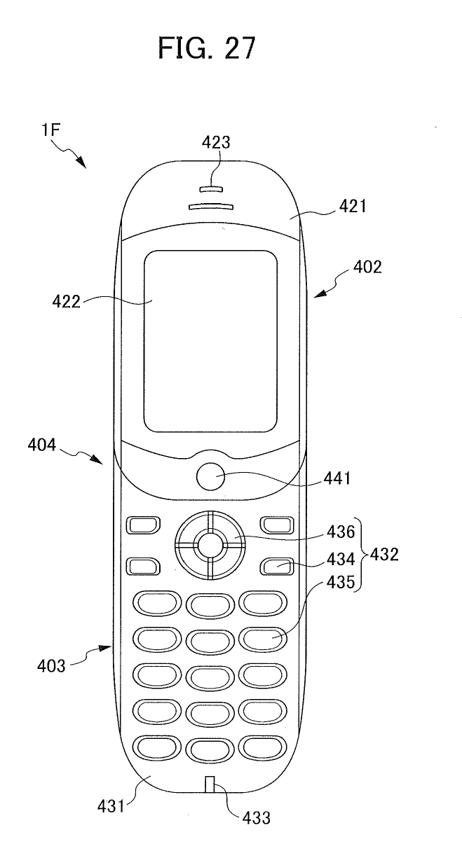

FIG. 27 to FIG. 29 are external views of a cellular telephone device 1F according to an eighth embodiment.

As illustrated in FIG. 27, the cellular telephone device 1F includes a display unit side body 402 as a first body and an operation unit side body 403 as a second body. The cellular telephone device 1F in the seventh embodiment has a so-called rotating (revolver-type) mechanism structure, and enables rotation of one body about a rotation axis 441 that extends in the direction of overlap between the operation unit side body 403 and the display unit side body 402. That is to say, the upper end of the operation unit side body 403 and the lower end of the display unit side body 402 are rotatably connected about the rotation axis 441 through a connecting portion 404 including the rotation axis 441.

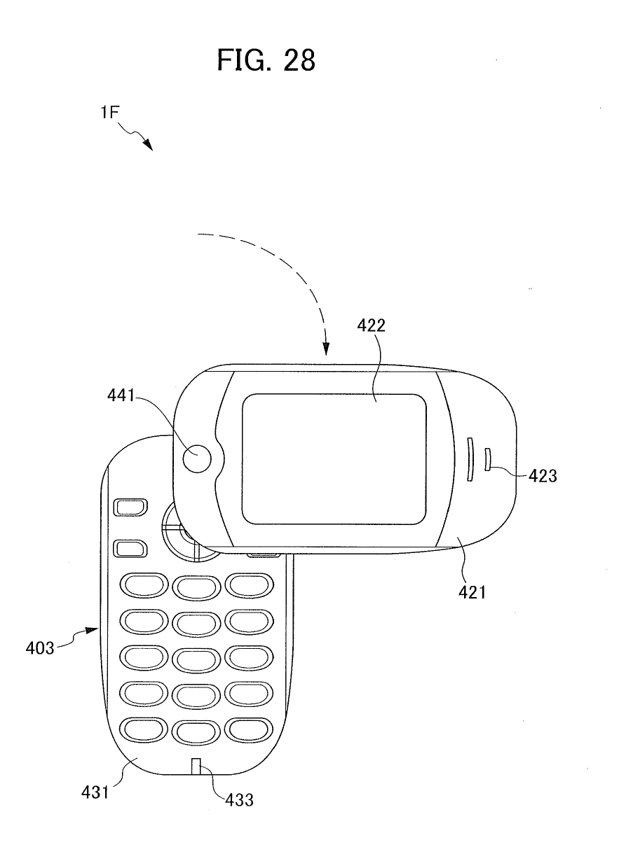

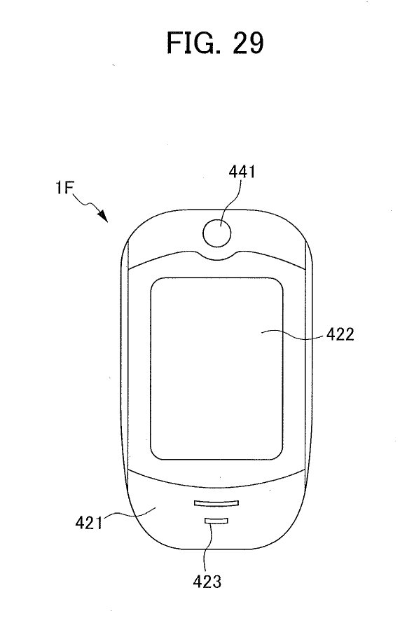

More specifically FIG. 27 is an external view of a cellular telephone device 1F in an opened state, FIG. 28 is an external view of a cellular telephone device 1F when rotates through 90 degree in a clockwise direction along the rotation axis 441, and FIG. 29 is an external view of a cellular telephone device 1F in a closed state. As described above, although a mechanism has been described in which there is a transition from an opened state and rotated in a clockwise direction to a closed state, the invention is not limited thereby, and may have a mechanism in which there is a transition from an opened state by rotating in a counter-clockwise direction to a closed state, and furthermore may have a mechanism in which there is a 360 degree rotation in either one direction or both directions.

The display unit side body 402 is configured from a front case 421 that forms a front surface and a rear case (not illustrated) that forms the rear surface. The front case 421 of the display unit side body 402 is disposed to expose a display unit 422 for displaying various types of information and an audio output unit 423 as a receiver for outputting of audio of conversation partner.

The display unit side body 403 is configured from a front case 431 that forms a front surface and a rear case (not illustrated) that forms the rear surface. The front case 431 of the operation unit side body 403 is configured to respective expose an operation key set 432, and an audio input unit 412 acting as a microphone for input of audio produced by a user during conversations.

The operation key set 432 is configured from a function setting operation key 434 for operating various settings or various functions such as an address book function, an email function, or the like, an input operation key 435 for input of a numeral of a telephone number, or a character or the like for an email, or the like, and a determination operation key 436 acting as an operation member for scrolling up and down or right and left, or determination of various types of operations, or the like.

When the respective keys that configure the operation key set 432 are pressed, the cellular telephone device 1F suitably refers to the key assign table in response to the opened state or closed state of the display unit side body 402 and the operation unit side body 403, the respective modes, or the type of application that is started up, and executes a function in accordance with the key assign table.

The audio input unit 433 is disposed on the opposite outer end to the connecting portion 404 in the longitudinal direction of the operation unit side body 403. That is to say, the audio input unit 433 is disposed on one outer end in the opened state of the cellular telephone device 1F.

The cellular telephone device 1F that is configured in this manner enables configuration of a plurality of antennas that use a conductive portion. This type of antenna enables use of a multi-input multi-output (MIMO) by a plurality of antennas, or use as a diversity antenna. The specific configuration will be described below.

### First Configuration Example

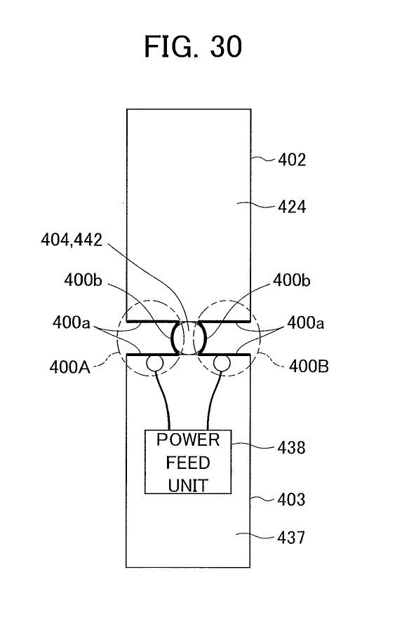

As illustrated in FIG. 30, the cellular telephone device 1F includes a display unit side body 402, an operation unit side body 403, a connecting portion 404, and a power feed unit 438. The display unit side body 402 includes a first conductive portion 424. The operation unit side body 403 includes a second conductive portion 437. The first conductive portion 424 and the second conductive portion 437 may correspond to the reference potential unit of the circuit base plate or the metal plate for the reference potential. Although in the first embodiment above, the power feed unit 438 has been described as disposed on the circuit base plate forming the second conductive portion 437, the invention is not limited in this regard.

The connecting portion 404 includes a third conductive portion 442. The connecting portion 404 connects the display unit side body 402 and the operation unit side body 403 to enable transition between a closed state stacking and disposing the operation unit side body 403 on the display unit side body 402, and an opened state in which the operation unit side body 403 is rotated from the closed state through a predetermined angle in relation to the display unit side body 402 about a rotation axis 441 along the direction of stacking.

In the opened state, the first conductive portion 424 and the second conductive portion 437 may be electrically connected through the third conductive portion 442. An opposed region (a region 400A and a region 400B in FIG. 30) that is formed by enclosure of three sides by the first conductive portion 424, the second conductive portion 437, and the third conductive portion 442 may be supplied with power from the power feed unit 438 to thereby operate as a magnetic current antenna.

More specifically, the respective side surfaces facing the first conductive portion 424 and the second conductive portion 437 configure a portion of a slit (denoted as “400a” in FIG. 30). The third conductive portion 442 that has a high frequency connection to the first conductive portion 424 and the second conductive portion 437 configures a portion of a slit (denoted as “400b” in FIG. 30). A slit that has this configuration functions as a magnetic current antenna by power supply from the power feed portion 438.

In this manner, the cellular telephone device 1F can form a magnetic current antenna in the opened state from the connecting portion 404, the first conductive portion 424, and the second conductive portion 437. In particular, since a structure is provided in which the surface for absorption and radiation of electromagnetic waves in the direction of stacking is not covered, interference between antennas is inhibited.

The frequency of the magnetic current antenna at which communication is enabled is determined by the longitudinal length of the slit (length “400a” in FIG. 30). More precisely, the longitudinal slit length is determined by λ/2 (wherein, n=1, 2, 3, . . . ) relative to the wavelength λ corresponding to the frequency f of the high frequency signal used in receiving and sending. In the cellular telephone device 1F, communication using a high frequency signal that has a target frequency is enabled by suitable adjustment of the longitudinal slit length.

The plurality of opposed region that is formed by enclosure of three sides by the first conductive portion 424, the second conductive portion 437, and the third conductive portion 442 may be formed with the same length as the longitudinal slit length.

When the cellular telephone device 1F has this configuration, operation of each slit is enabled as a magnetic current antenna that executes sending and receiving using the same resonance frequency to thereby realize MIMO or a diversity antenna.

### Second Configuration Example

Furthermore the third conductive portion 442 may be configured from a metallic plate (metal plate member) that fixes the display unit side body 402 and the operation unit side body 403. In this configuration, in the opened state, the first conductive portion 424 and the second conductive portion 437 are electrically connected through the metallic plate (third conductive portion 442). An opposed region is formed by enclosure of three sides by the first conductive portion 424, the second conductive portion 437, and the metallic plate (third conductive portion 442).

More precisely, the metallic plate plays the role of a member that joins the display unit side body 402 and the operation unit side body 403, and furthermore configures the first conductive portion 424 and the second conductive portion 437 together with the slit. The slit portion functions as a slit antenna (magnetic current antenna) by supply of power from the power feed unit 438.

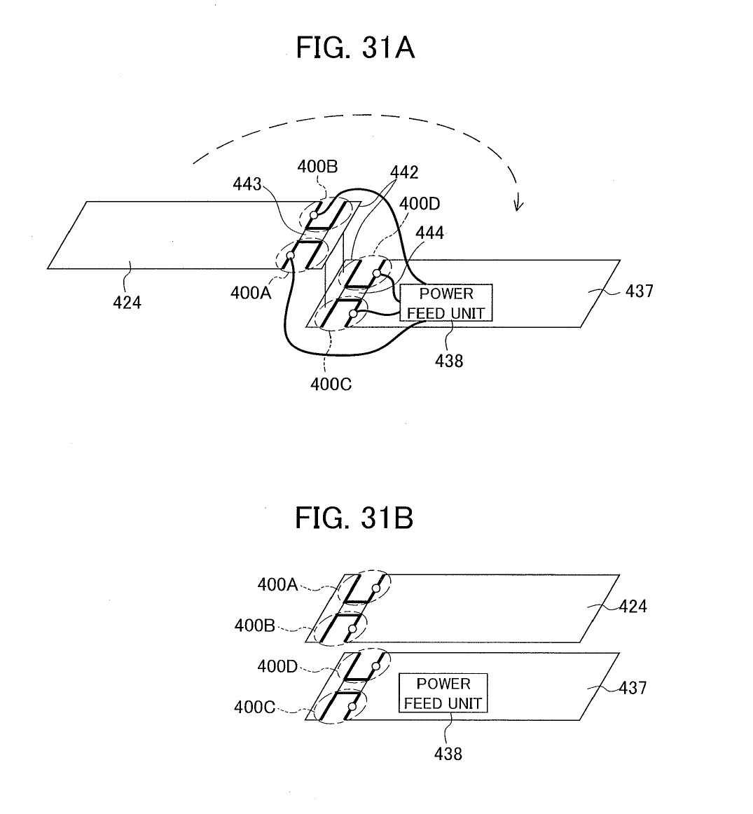

As illustrated in FIG. 31A and FIG. 31B, one end of the first conductive portion 424 and one end of the metallic plate (third conductive portion 442) that faces the one end are electrically connected by a conductive first connection member 443. One end of the second conductive portion 437 and the other end of the metallic plate (third conductive portion 442) that faces the one end is electrically connected by a conductive second connection member 444. The first connection member 443 and the second connection member 444 project towards the connecting portion 404 on the reference potential pattern of the circuit base plate. The first connection member 443 and the second connection member 444 may be a metal-plate metallic member.

The configuration of the cellular telephone device 1F in the opened state will be described below making reference to FIG. 31A. The first opposed region (slit 400A in FIG. 31A) and the second opposed region (slit 400B in FIG. 31A) that are formed by enclosure of three sides by one end of the first conductive portion 424, one end of the metallic plate, and the first connection member 443 may be supplied with power from the power feed unit 438 to thereby operate as a magnetic current antenna. The third opposed region (slit 400C in FIG. 31A) and the fourth opposed region (slit 400D in FIG. 31A) that are formed by enclosure of three sides by one end of the second conductive portion 437, one end of the metallic plate, and the second connection member 444 may be supplied with power from the power feed unit 438 to thereby operate as a magnetic current antenna.

In this manner, since the surface for absorption and radiation of electromagnetic waves of the slit 400A, the slit 400B, the slit 400C and the slit 400D of the cellular telephone device 1F is not covered in the opened position, production of interference is inhibited, and use as a superior antenna is enabled.

Next, the configuration of the cellular telephone device 1F in the closed state will be described below making reference to FIG. 31B. For the sake of convenience, FIG. 31B shows the display unit side body 402 and the operation unit side body 403 in a divided configuration.

The first opposed region (slit 400A in FIG. 31B) and the fourth opposed region (slit 400D in FIG. 31B) are opposed with reference to the direction of stacking. Either one of the first opposed region or the fourth opposed region is supplied with power from the power feed unit 438 to thereby operate as a magnetic current antenna.

The second opposed region (slit 400B in FIG. 31B) and the third opposed region (slit 400C in FIG. 31B) are opposed with reference to the direction of stacking. Either one of the second opposed region or the third opposed region is supplied with power from the power feed unit 438 to thereby operate as a magnetic current antenna.

In this manner, the cellular telephone device 1F is configured so that, in the closed state, the slit 400A and the slit 400D are opposed in the direction of stacking, or the slit 400B and the slit 400C are opposed in the direction of stacking. Thus, the cellular telephone device 1F configures a magnetic current antenna by power supply from the power feed unit 438 to one of the slit 400A or the slit 400D. Furthermore, the cellular telephone device 1F configures a magnetic current antenna by power supply from the power feed unit 438 to one of the slit 400B or the slit 400C. Since the surface for absorption and radiation of electromagnetic waves is not covered, this magnetic current antenna does not tend to produce interference and use as a superior antenna is enabled.

Furthermore, when this cellular telephone device 1F is in a rotated state that is between the opened state and the closed state, the region (first opposed region (slit 400A), third opposed region (slit 400C), or the second opposed region (slit 400B) and the fourth opposed region (slit 400D)) in which the opposed region is not closed in the direction of stacking is supplied with power from the power feed unit 438 to thereby operate as a slit magnetic current antenna. When a portion of the opposed region in the direction of stacking in this cellular telephone device 1F is closed, the region (the first opposed region (slit 400A) and the third opposed region (slit 400C), or the second opposed region (slit 400B) and the fourth opposed region (slit 400D)) in which the opposed region is closed in the direction of stacking is supplied with power from the power feed unit 438 to thereby operate as a slit magnetic current antenna.

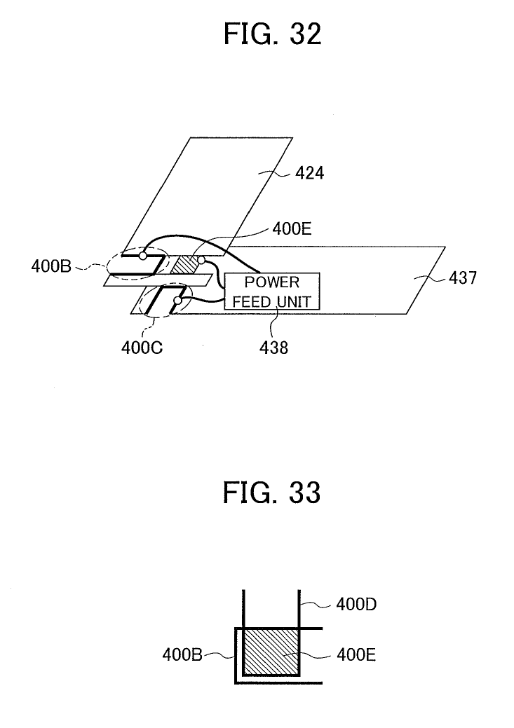

In the seventh embodiment, as illustrated in FIG. 32, the rotated state between the opened state and the closed state is the state in which the cellular telephone device 1F is rotated through 90 degrees along the rotation axis 441 from the opened state, or the state in which the cellular telephone device 1F is rotated through 90 degrees along the rotation axis 441 from the closed state.

Since the surface for absorption and radiation of electromagnetic waves in the direction of stacking of the slit 400A and the slit 400C of the cellular telephone device 1F is not covered in the 90 degree rotation from the opened position, superior maintenance of magnetic current antenna performance can be constantly maintained.

The slit 400B and the slit 400D of the cellular telephone device 1F are superimposed in the vertical direction in the rotated state between the opened state and the closed state. When this configuration is observed from above, as illustrated in FIG. 33, a closed quadrilateral 400E is formed from the slit 400B and the slit 400D. When the quadrilateral 400E is supplied with power from the power feed unit 438, a so-called slot antenna is formed.

Therefore, in the rotated state between the opened state and the closed state, the cellular telephone device 1F enables configuration of two slit antennas that are enclosed on three sides and one slot antenna that is enclosed on four sides. In the rotated state between the opened state and the closed state, since the region that is enclosed on four side is operated as a slot antenna, it is preferred that the cellular telephone device 1F is designed so that the slit 400B and the slit 400D are in sufficient proximity to configure a slot antenna.

### Third Configuration Example

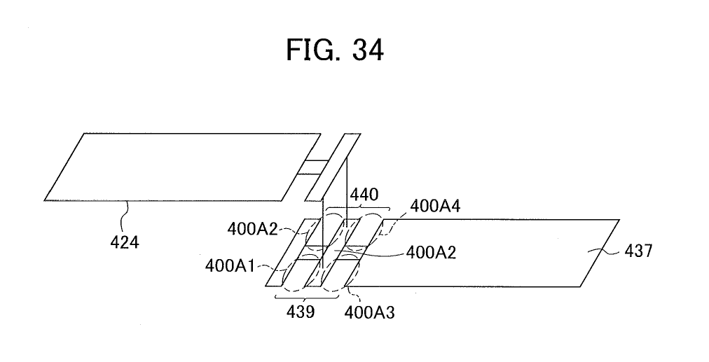

As illustrated in FIG. 34, a first notched portion 439 and a second notched portion 440 are formed with a predetermined shape in the second conductive portion 37 to exhibit bilateral symmetry in a longitudinal direction. A metallic plate (third conductive portion 442) is disposed to partition the first notched portion 439 and the second notched portion 440 to thereby form a first slit 400A1, a second slit 400A2, a third slit 400A3 and a fourth slit 400A4.

In the process of transition from the opened state to the intermediate state of the closed state, the third slit 400A3 or the fourth slit 400A4 that are not closed in the direction of stacking are supplied with power from the power feed unit 438 to thereby operate as a magnetic current antenna. In the seventh embodiment, the intermediate state is a state in which the cellular telephone device 1F is rotated through 90 degrees along the rotation axis 441 from the opened state.

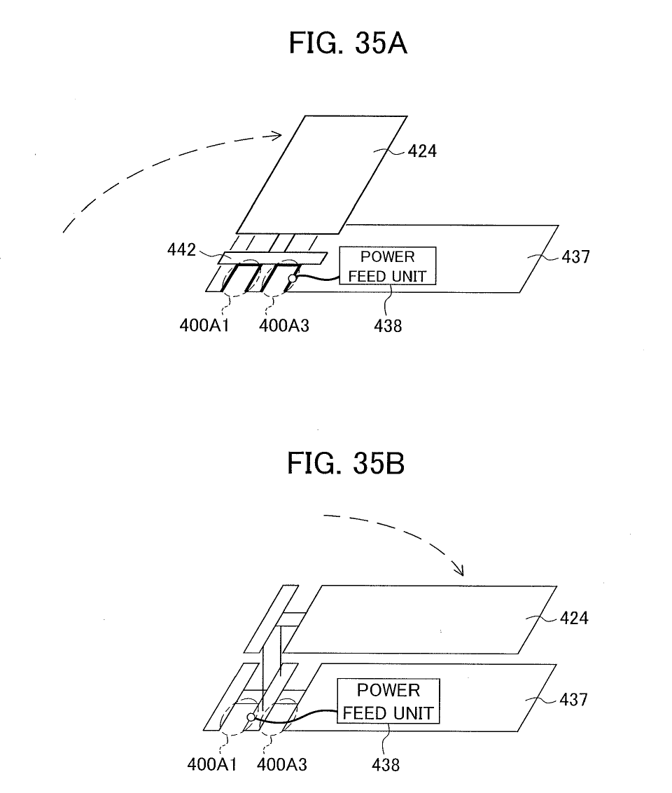

This means that when the cellular telephone device 1F is rotated in a clockwise direction from the opened state, the surface for absorption and radiation of electromagnetic waves in the direction of stacking of the third slit 400A3 is not covered, and when the cellular telephone device 1F is rotated in a counterclockwise direction from the opened state, the surface for absorption and radiation of electromagnetic waves in the direction of stacking of the fourth slit 400A4 is not covered. FIG. 35A illustrates the former configuration.

In the process of transition from the intermediate state to the closed state, the first slit 400A1 or the second slit 400A2 that are not closed in the direction of stacking are supplied with power from the power feed unit 438 to thereby operate as a magnetic current antenna. When executing a transition from the intermediate state to the closed state, the transition is executed from a state in which the cellular telephone device 1F is rotated through 90 degrees to a closed state in which rotation occurs along the rotation axis 441. FIG. 35B illustrates the former configuration.

This means that when the cellular telephone device 1F is rotated in a clockwise direction from the intermediate state, the surface for absorption and radiation of electromagnetic waves in the direction of stacking of the first slit 400A1 is not covered, and when the cellular telephone device 1F is rotated in a counterclockwise direction from the intermediate state, the surface for absorption and radiation of electromagnetic waves in the direction of stacking of the second slit 400A2 is not covered.

If it is assumed that the cellular telephone device 1F is rotated in the clockwise direction from the opened state along the rotation axis 441, power supply to the third slit 400A3 is executed from the power feed unit 438 from the opened state until the intermediate state and thereby enables use as a magnetic current antenna. If the object of power supply in the cellular telephone device 1F is changed from the intermediate state to the closed state, power supply to the first slit 400A1 is executed from the power feed unit 438 and thereby enables use as a magnetic current antenna.

During a transition in the cellular telephone device 1F from the opened state to the closed state, this configuration enables at least one slit to operate as a magnetic current antenna, and therefore enables operation without communication failure.

### Fourth Configuration Example

Furthermore the first conductive portion 424 or the second conductive portion 437 is connected to the reference potential. The first conductive portion 424 and the second conductive portion 437 have a high frequency connection through the connecting portion 404, and therefore operate as an inverted F antenna.

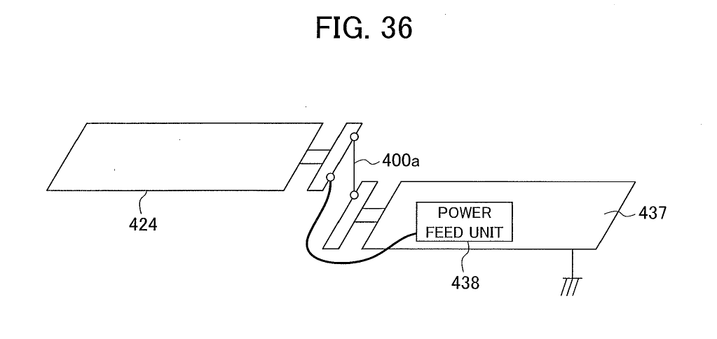

More specifically, as illustrated in FIG. 36, the first conductive portion 424 and the second conductive portion 437 in the cellular telephone device 1F exhibit a conductive configuration via a conducting line 400a, one conductive portion (the second conductive portion 437 in the fourth example) is connected to the reference potential (GND), and the other conductive portion (the first conductive portion 424 in the fourth example) is connected to the power feed portion 438 to thereby enable operation as an inverted F antenna.

Furthermore, the inverted F antenna is operated as a so-called electric current antenna. As used herein, since the inverted F antenna and the slit antenna (magnetic current antenna) exhibit mutually orthogonal polarization surfaces, high isolation is enabled together with low correlation. Thus, the cellular telephone device 1F enables simultaneous operation of an inverted F antenna and a slit antenna.

The cellular telephone device 1F enables communication in the same frequency band as the slit antenna by adjustment of the length of the inverted F antenna element. Thus, the cellular telephone device 1F combines use of an inverted F antenna and a slit antenna, and thereby realizes MIMO or a diversity antenna.

### Fifth Configuration Example

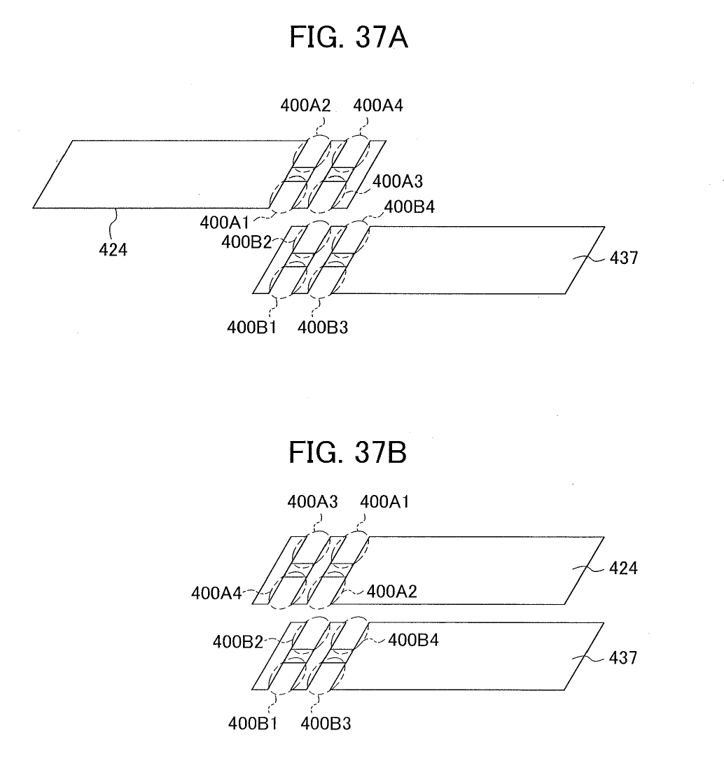

As illustrated in FIG. 37, the cellular telephone device 1F may form a plurality of slits in the first conductive portion 424 and the second conductive portion 437. Although FIG. 37 illustrates the first conductive portion 424 forming four slits (the slit 400A1, the slit 400A2, the slit 400A3, and the slit 400A4), and the second conductive portion 427 also forming four slits (the slit 400B1, the slit 400B2, the slit 400B3, and the slit 400B4), the invention is not limited in this regard.

In this configuration, as illustrated in FIG. 37A, the cellular telephone device 1F in the opened state configures eight magnetic current antennas by respective power supply to the eight slits. Furthermore, in the closed state, as illustrated in FIG. 37B, the cellular telephone device 1F configures four magnetic current antennas by power supply to the slit 400A1 or the slit 400B4, the slit 400A2 or the slit 400B3, the slit 400A3 or the slit 400B2, and the slit 400A4 or the slit 400B1, that are respectively opposed in the direction of stacking.

Therefore, the surface for absorption and radiation of electromagnetic waves of the cellular telephone device 1F is not covered in the opened state and the closed state. Therefore, interference is inhibited in the cellular telephone device 1F, and simultaneous use is enabled in relation to a plurality of magnetic current antennas to thereby realize MIMO or a diversity antenna.

What is claimed is:

1. A portable electronic device comprising:
a first body that has a first conductive portion;
a second body that has a second conductive portion;
a connecting portion that has a third conductive portion, and is configured to connect to enable transition between a closed state and an opened state; and
a power feed unit;
wherein, in the opened state, the first conductive portion and the second conductive portion are electrically connected through the third conductive portion; and
wherein, in the opened state, an opposed region that is formed by enclosure of at least three sides by the first conductive portion, the second conductive portion, and the third conductive portion is supplied with power from the power feed unit to operate as a magnetic current antenna.

2. The portable electronic device according to claim 1, wherein the connecting portion is configured to rotatably connect the first body and the second body about a predetermined rotation axis to enable transition between the closed state in which the first body and the second body are disposed in a stacked configuration, and the opened state in which a mutually opposed surface of the first body and the second body in the closed state is exposed.

3. The portable electronic device according to claim 2,
wherein the first conductive portion and the second conductive portion are mutually opposed in the closed state, and
wherein the power feed unit is connected to either one of the first conductive portion and the second conductive portion in the closed state.

4. The portable electronic device according to claim 2,
wherein the second conductive portion is not electrically conductive in relation to the first conductive portion and the third conductive portion in the closed state, and is not electrically conductive in relation to a reference potential unit; and
wherein the power feed unit is connected to the second conductive portion in the closed state.

5. The portable electronic device according to claim 1,
wherein the connecting portion is configured to connect the first body and the second body to enable transition between the closed state in which the first body and the second body are disposed in a stacked configuration, and the opened state in which an upper surface of the first body and an upper surface of the second body are disposed to be visible from the same direction.

6. The portable electronic device according to claim 5, further comprising;
a first opening is formed in the second conductive portion to operate as a second magnetic current antenna by supply of power from the power feed unit in the closed state to the end on the opposite side to the end on the side forming the opposed region in the opened state; and
a first notched portion is formed in the first conductive portion in a region opposed to the first opening in the closed state, the region forming the opposed region in the opened state.

7. The portable electronic device according to claim 6,
wherein the first opening and the first notched portion are configured in an elongated configuration; and
wherein the longitudinal length of the first notched portion is greater than or equal to the longitudinal length of the first opening.

8. The portable electronic device according to claim 5, further comprising;
a second opening is formed in the first conductive portion to operate as a third magnetic current antenna by supply of power from the power feed unit in the closed state to the end on the opposite side to the end on the side forming the opposed region in the opened state; and
a second notched portion is formed in the second conductive portion in a region opposed to the second opening in the closed state, the region forming the opposed region in the opened state.

9. The portable electronic device according to claim 8,
wherein the second opening and the second notched portion are formed in an elongated configuration; and
wherein the longitudinal length of the second notched portion is greater than or equal to the longitudinal length of the second opening.

10. The portable electronic device according to claim 1,
wherein the power feed unit includes a first power feed unit;
wherein the connecting portion is configured to connect the first body and the second body to enable transition between the closed state in which the principal surface of the first body and the principal surface of the second body are opposed and disposed with respect to a direction of stacking, and the opened state in which the second body slides in a horizontal direction with respect to the first body from the closed state, a portion of the principal surface of the first body being exposed, and another portion being covered by the principal surface of the second body;
wherein, in either or both of the opened state and the closed state, the first conductive portion and the second conductive portion are electrically connected through the third conductive portion; and
wherein, in either or both of the opened state and the closed state, the opposed region that is formed by enclosure of at least three sides by the first conductive portion, the second conductive portion, and the third conductive portion is supplied with power from the first power feed unit to operate as a magnetic current antenna.

11. The portable electronic device according to claim 10,
wherein the power feed unit includes a second power feed unit;
wherein the second conductive portion includes a first portion and a second portion;
wherein the third conductive portion includes a first portion and a second portion; and
wherein the first conductive portion and the first portion of the second conductive portion are electrically connected through the first portion of the third conductive portion;
wherein an opposed region that is enclosed by the first conductive portion, the first portion of the second conductive portion and the first portion of the third conductive portion is supplied with power from the first power feed unit to operate as a magnetic current antenna;
wherein the first conductive portion and the second portion of the second conductive portion are electrically connected through the second portion of the third conductive portion; and
wherein the second portion of the second conductive portion is supplied with power from the second power feed unit to operate as an inverted F antenna.

12. The portable electronic device according to claim 10, further comprising a control unit that operates one of the first power feed unit and the third power feed unit;
wherein the power feed unit includes the third power feed unit;
wherein the first conductive portion and the second conductive portion include opposed surfaces that are mutually opposed in the opened state and the closed state;
wherein the end on one side in the planar direction of the opposed surface is supplied with power from the first power feed unit to operate as a first magnetic current antenna;
wherein the end on the other side in the planar direction of the opposed region is supplied with power from the third power feed unit to operate as a second magnetic current antenna; and
wherein the control unit compares a communication quality of the first magnetic current antenna and a communication quality of the second magnetic current antenna, and executes control to perform communication using the magnetic current antenna that has the higher communication quality.

13. The portable electronic device according to claim 1,
wherein the connecting portion is configured to connect the first body and the second body to enable transition between the closed state in which the principal surface of the first body and the principal surface of the second body are opposed by disposing in a stacked configuration, a first opened state in which the first body is rotated through a predetermined angle in relation to the second body about a first rotation axis enabling rotation from the closed state to a first direction, and in which the principal surface of the first body and the principal surface of the second body are exposed to be visible from the same direction, and a second opened state in which the second body is rotated through a predetermined angle in a planar direction about a second rotation axis enabling rotation from the first opened state in a second direction that is orthogonal to the first direction and with the principal surface of the first body and the principal surface of the second body remaining visible from the same direction;
wherein the first conductive portion and the second conductive portion are electrically connected through the third conductive portion; and
wherein, in the first opened state, the opposed region that is formed by enclosure of at least three sides by the first conductive portion, the second conductive portion, and the third conductive portion is supplied with power from the power feed unit to operate as a magnetic current antenna.

14. The portable electronic device according to claim 13,
wherein, in the second opened state, the first conductive portion and the second conductive portion are electrically connected through the third conductive portion; and
wherein, in the second opened state, the opposed region that is formed by enclosure of at least three sides by the first conductive portion, the second conductive portion, and the third conductive portion is supplied with power from the power feed unit to operate as a magnetic current antenna.

15. The portable electronic device according to claim 1,
wherein the connecting portion is configured to connect the first body and the second body to enable transition between the closed state stacking and disposing the second body on the first body, and the opened state in which the second body is rotated from the closed state through a predetermined angle in relation to the second body about an axis along the direction of stacking.

16. The portable electronic device according to claim 15,
wherein the third conductive portion is configured from a metal plate member for fixing the first body and the second body;
wherein, in the opened state, the first conductive portion and the second conductive portion are electrically connected through the metal plate member; and
wherein, in the opened state, the opposed region is a region that is formed by enclosure of three sides by the first conductive portion, the second conductive portion, and the metal plate member.

17. The portable electronic device according to claim 16,
wherein one end of the first conductive portion and one end of the metal plate member facing the one end of the first conductive portion are electrically connected by a first connection member having conductive properties;
wherein one end of the second conductive portion and another end of the metal plate member facing the one end of the second conductive portion are electrically connected by a second connection member having conductive properties;
wherein, in the opened state, a first opposed region and a second opposed region formed by enclosure of three sides by the one end of the first conductive portion, the one end of the metal plate member, and the first connection member are respectively supplied with power from the power feed unit to operate as a magnetic current antenna;
wherein, in the opened state, a third opposed region and a fourth opposed region formed by enclosure of three sides by one end of the second conductive portion, another end of the metal plate member, and the second connection member are respectively supplied with power from the power feed unit to operate as a magnetic current antenna;
wherein, in the closed state, the first opposed region and the fourth opposed region face the direction of stacking;
wherein, in the closed state, either one of the first opposed region and the fourth opposed region is supplied with power from the power feed unit to operate as a magnetic current antenna; and
in the closed state, the second opposed region and the third
wherein, opposed region face the direction of stacking, and
wherein, either one of the second opposed region and the third opposed region is supplied with power from the power feed unit to operate as a magnetic current antenna.

18. The portable electronic device according to claim 17,
wherein, in a rotating state between the opened state and the closed state,
the first opposed region and the third opposed region, or the second opposed region and the fourth opposed region in which the opposed region is not covered in the direction of stacking are supplied with power from the power feed unit and operate as a slit-shaped magnetic current antenna; and
a portion of the opposed region is covered in the direction of stacking enables the region formed by the first opposed region and the third opposed region, or the second opposed region and the fourth opposed region to be supplied with power from the power feed unit and operate as a slot-shaped magnetic current antenna.

19. The portable electronic device according to claim 17,
wherein the second conductive portion includes a first notched portion and a second notched portion having a predetermined shape and exhibiting bilateral symmetry in the longitudinal direction, the metal plate member disposed to divide the first notched portion and the second notched portion, and a first slit, a second slit, a third slit and a fourth slit are formed;
wherein, in a process of transition from the opened state to an intermediate state between the opened state and the closed state, the third slit or the fourth slit which are not covered in the direction of stacking is supplied with power from the power feed unit and operate as a magnetic current antenna; and
wherein, in the process of transition from the intermediate state to the closed state, the first slit or the second slit which are not covered in the direction of stacking is supplied with power from the power feed unit and operate as a magnetic current antenna.

20. The portable electronic device according to claim 15,
wherein the first conductive portion or the second conductive portion is connected to a reference potential; and
wherein the first conductive portion and the second conductive portion are configured with a high frequency connection through the connecting portion to operate as an inverted F antenna.
